(19) United States
(12) Patent Application Publication
(10) Pub. No.: US 2006/0148649 A1
(43) Pub. Date: Jul. 6, 2006

(54) Substituted n-aryl nitrogen heterocycles

(75) Inventors: Hans-Georg Schwarz, Langenfeld (DE); Roland Andree, Langenfeld (DE); Dorothee Hoischen, Dusseldorf (DE); Karl-Heinz Linker, Leverkusen (DE); Joachim Kluth, Langenfeld (DE); Otto Schallner, Monheim (DE); Mark Wilhelm Mark Drewes, Langenfeld (DE); Peter Dahmen, Neuss (DE); Dieter Feucht, Monheim (DE); Rolf Pontzen, Leichlingen (DE); Peter Losel, Leverkusen (DE); Thomas Auler, Bad Soden (DE); Martin Jeffrey Hills, Idstein (DE); Heinz Kehne, Hofheim (DE)

Correspondence Address: CONNOLLY BOVE LODGE & HUTZ, LLP, P O BOX 2207, WILMINGTON, DE, 19899, US

(73) Assignee: Bayer CropScience GmbH Patents and Licensing, Frankfurt am Main (DE)

(21) Appl. No.: 10/546,128

(22) PCT Filed: Feb. 10, 2004
(86) PCT No.: PCT/EP04/01198

§ 371 Date: Aug. 19, 2005

(30) Foreign Application Priority Data
Feb. 20, 2003 (DE) 103071423

(51) Int. Cl. A01N 43/707; A01N 43/54; A01N 43/653; A01N 43/56

(52) U.S. Cl. 504/229; 504/239; 504/273; 504/282; 544/182; 544/309; 548/317.5; 548/263.4

(57) ABSTRACT

The invention relates to novel substituted N-aryl nitrogen heterocycles of the formula (I), 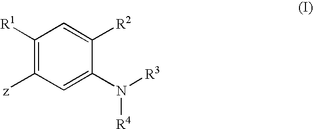 in which,
R¹, R², R³, R⁴ and Z are as defined in the description, and to a process for their preparation and to their use as crop treatment agents.

The invention relates to novel substituted N-aryl nitrogen heterocycles, to a process for their preparation and to their use as crop treatment agents, in particular as herbicides and as arthropodicides.

It is already known that certain substituted N-aryl nitrogen heterocycles have herbicidal and to a certain extent also insecticidal and acaricidal properties (cf. EP 597 360 A1, EP 688 773 A1/U.S. Pat No. 5,665,681 A, EP 745 599 A2, EP 1 157 991 A2/U.S. Pat. No. 6,444,615 A, U.S. Pat. No. 5,679,791 A, U.S. Pat. No. 5,726,126 A, U.S. Pat. No. 5,872,253 A, WO 85/01939 A1/U.S. Pat. No. 5,136,868 A, WO 92/02509 A1, WO 92/06962 A1/U.S. Pat. No. 5,281,571 A, WO 92/11244 A1/U.S. Pat. No. 5,356,863 A). However, the properties of the substituted N-aryl nitrogen heterocycles described in these documents do not, for various reasons, satisfy the high demands placed on modern crop treatment agents.

This invention now provides novel substituted N-aryl nitrogen heterocycles of the formula (I), 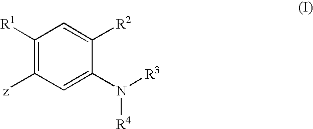
in which
R¹ represents hydrogen, cyano or halogen,
R² represents nitro, chlorine, bromine, cyano, thiocarbamoyl or represents in each case optionally halogen-substituted alkyl or alkoxy having in each case 1 to 6 carbon atoms,
R³ and R⁴ together with the N atom to which they are attached represent monocyclic or bicyclic (including spirocyclic) heterocyclyl which has up to 10 carbon atoms, up to 5 N atoms and optionally additionally one O atom or one S atom and which optionally contains 1 or 2 oxo groupings (C═O), thioxo groupings (C═S) or sulfonyl groupings (SO₂) and which is optionally substituted by hydroxyl, amino, nitro, cyano, carbamoyl, thiocarbamoyl, formyl, halogen, C₁-C₆-alkyl, cyano-C₁-C₆-alkyl, C₁-C₆-haloalkyl, C₁-C₆-alkoxy-C₁-C₆-alkyl, C₁-C₆-alkyl-carbonyl-C₁-C₆-alkyl, C₁-C₆-alkoxy-carbonyl-C₁-C₆-alkyl, C₁-C₆-alkoxy, C₁-C₆-haloalkoxy, C₁-C₆-alkylthio, C₁-C₆-haloalkylthio, C₁-C₆-alkylsulfinyl, C₁-C₆-haloalkylsulfinyl, C₁-C₆-alkylsulfonyl, C₁-C₆-haloalkylsulfonyl, C₁-C₆-alkyl-carbonyl, C₁-C₆-haloalkyl-carbonyl, C₁-C₆-alkoxy-carbonyl, C₁-C₆-haloalkoxy-carbonyl, C₁-C₆-alkylamino-carbonyl, di-(C₁-C₄-alkyl)aminocarbonyl, di-(C₁-C₄-alkyl)aminosulfonyl, C₁-C₃-alkylenedioxy, C₁-C₃-haloalkylenedioxy or C₃-C₆-cycloalkyl, and
Z represents one of the heterocyclic groupings (Z¹) to (Z⁵¹) below 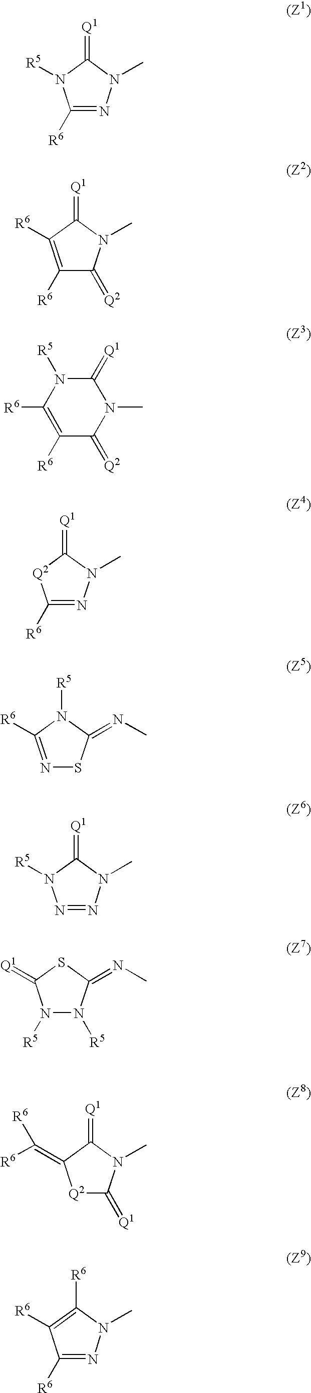 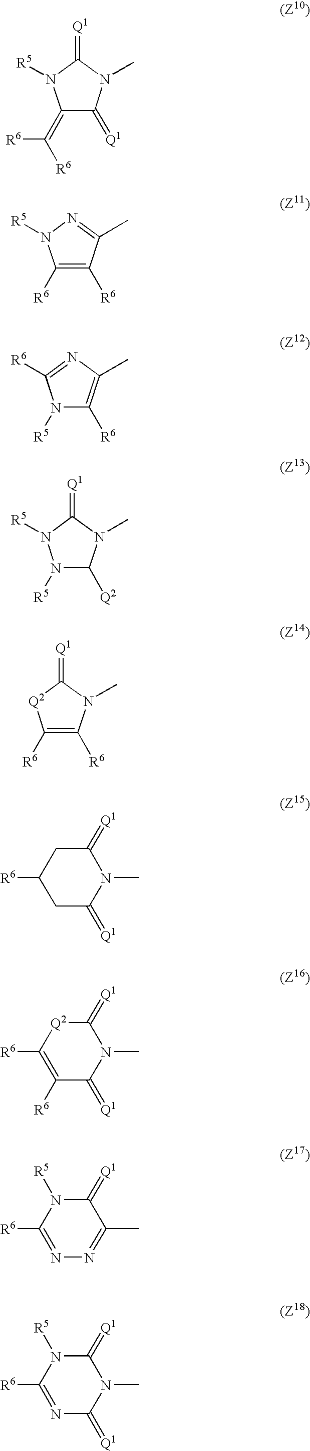 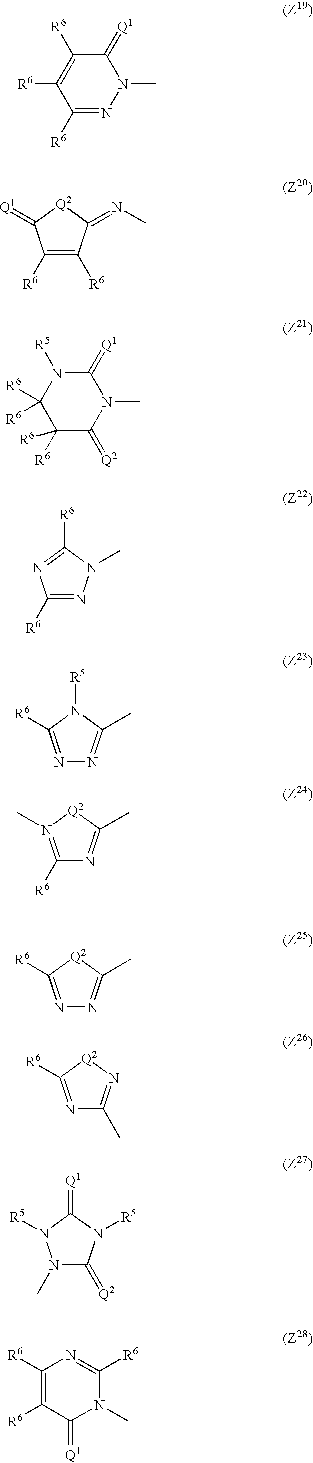 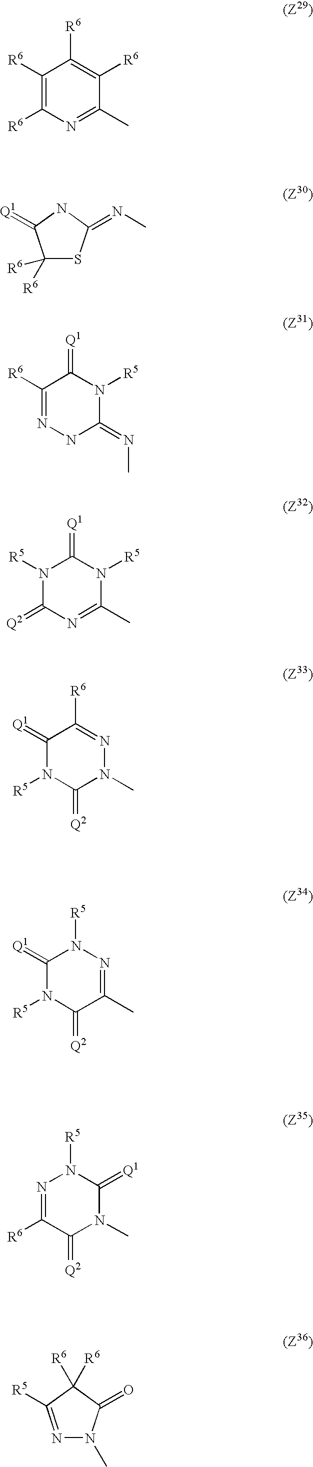 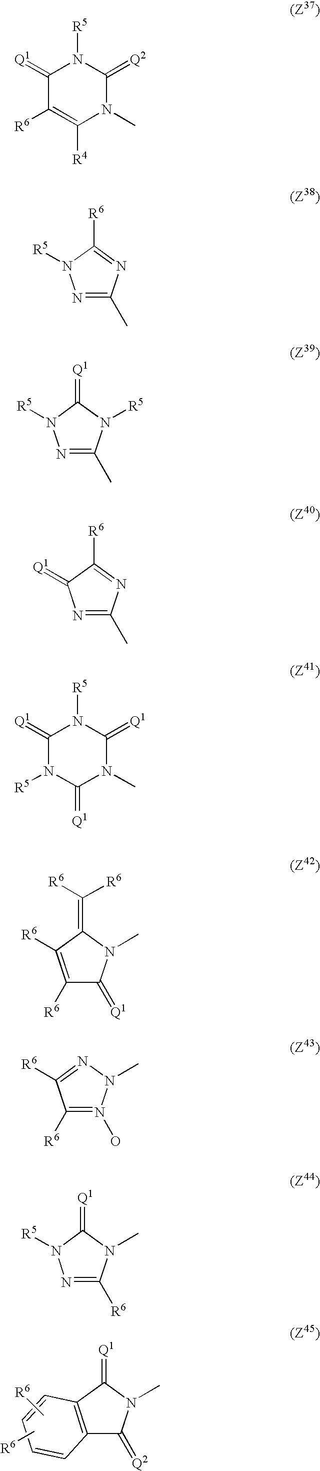 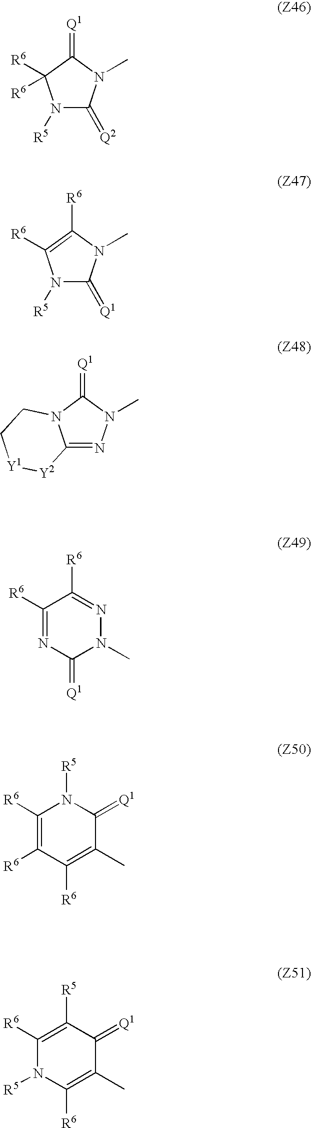
   where
Q¹ represents O (oxygen) or S (sulfur),
Q² represents O (oxygen) or S (sulfur),
R⁵ represents hydrogen, hydroxyl, amino, cyano, or represents in each case optionally cyano-, halogen- or C₁-C₆-alkoxy-substituted alkyl, alkoxy or alkoxycarbonyl having in each case 1 to 6 carbon atoms in the alkyl groups, in each case optionally cyano-, halogen- or C₁-C₆-alkoxy-carbonyl-substituted alkenyl or alkynyl having in each case 2 to 6 carbon atoms, represents in each case optionally cyano-, halogen- or C₁-C₄-alkyl-substituted cycloalkyl or cycloalkylalkyl having in each case 3 to 6 carbon atoms in the cycloalkyl group and, if appropriate, 1 to 4 carbon atoms in the alkyl moiety, or represents in each case optionally cyano-, nitro-, halogen-, C₁-C₄-alkyl-, C₁-C₄-haloalkyl-, C₁-C₄-alkoxy- or C₁-C₄-haloalkoxy-substituted phenyl or phenyl-C₁-C₄-alkyl, and
R⁶ represents hydrogen, amino, nitro, cyano, carboxyl, carbamoyl, thio-carbamoyl, halogen, represents in each case optionally cyano-, halogen- or C₁-C₄-alkoxy-substituted alkyl, alkoxy, alkoxycarbonyl, alkylthio, alkylsulfinyl, alkylsulfonyl, alkylsulfonyloxy, alkylamino or dialkylamino having in each case 1 to 6 carbon atoms in the alkyl groups, represents in each case optionally cyano- or halogen-substituted alkenyl, alkynyl, alkenyloxy, alkynyloxy, alkenylthio or alkynylthio having in each case 2 to 6 carbon atoms, or represents in each case optionally cyano-, halogen- or C₁-C₄-alkyl-substituted cycloalkyl or cycloalkylalkyl having in each case 3 to 6 carbon atoms in the cycloalkyl group and, if appropriate, 1 to 4 carbon atoms in the alkyl moiety,
   where, if appropriate, two adjacent radicals—R⁵ and R⁵, R⁶ and R⁶ or R⁵ and R⁶—together represent alkanediyl or alkenediyl having in each case up to 6 carbon atoms and being optionally substituted and/or optionally interrupted by O (oxygen), S (sulfur) or a grouping from the group consisting of —SO—, —SO₂—, —NH— or —N(C₁-C₄-alkyl)- at the beginning (or at the end) or within the hydrocarbon chain,
Y¹ represents O (oxygen), S (sulfur), SO, SO₂, NH, N(C₁-C₄-alkyl) or methylene and
Y² represents a single bond or represents O (oxygen), S (sulfur), SO, SO₂, NH or N(C₁-C₄-alkyl),
   where in each individual case Y¹ and Y² are different.

In the definitions, the hydrocarbon chains, such as alkyl or alkanediyl, are in each case straight-chain or branched—including in combination with heteroatoms, such as in alkoxy.

Preferred substituents or ranges of the radicals present in the formulae given above and below are defined below.
R¹ preferably represents hydrogen, cyano, fluorine, chlorine or bromine.
R² preferably represents nitro, cyano, chlorine, bromine, thiocarbamoyl or represents in each case optionally fluorine- and/or chlorine-substituted alkyl or alkoxy having in each case 1 to 4 carbon atoms.
R³ and R⁴ together with the N atom to which they are attached preferably represent monocyclic or bicyclic (including spirocyclic) heterocyclyl which has up to 9 carbon atoms, up to 4 N atoms and optionally additionally one O atom or one S atom, which optionally contains 1 or 2 oxo groupings (C═O), thioxo groupings (C═S) or sulfonyl groupings (SO₂) and which is optionally substituted by hydroxyl, amino, nitro, cyano, carbamoyl, thiocarbamoyl, formyl, halogen, C₁-C₄-alkyl, cyano-C₁-C₄-alkyl, C₁-C₄-haloalkyl, C₁-C₄-alkoxy-C₁ -C₄-alkyl, C₁-C₄-alkyl-carbonyl-C₁-C₄-alkyl, C₁-C₄-alkoxy-carbonyl-C₁-C₄-alkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₄-alkyl-carbonyl, C₁-C₄-haloalkyl-carbonyl, C₁-C₄-alkoxy-carbonyl, C₁-C₄-haloalkoxy-carbonyl, C₁-C₄-alkylamino-carbonyl, di-(C₁-C₃-alkyl)aminocarbonyl, di-(C₁-C₃-alkyl)aminosulfonyl, C₁-C₃-alkylenedioxy, C₁-C₂-haloalkylenedioxy or C₃-C₆-cycloalkyl.
   Z preferably represents one of the heterocyclic groupings (Z¹) to (Z⁵¹) below 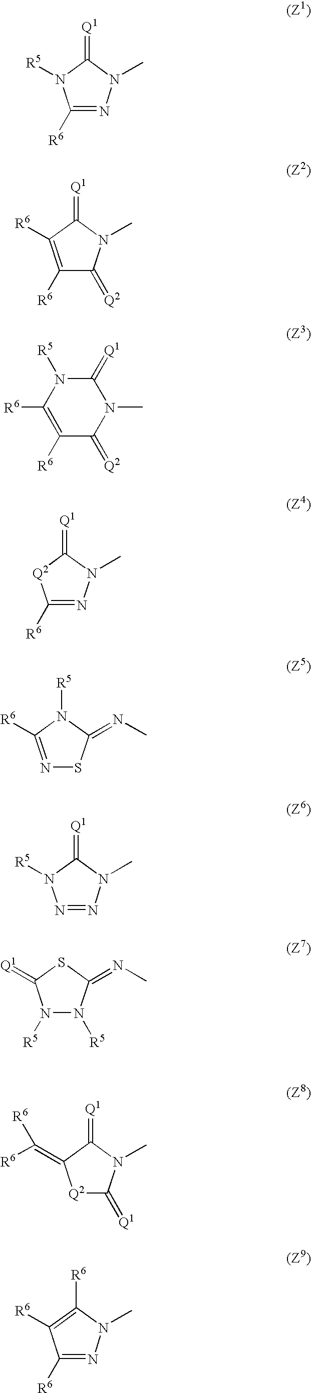 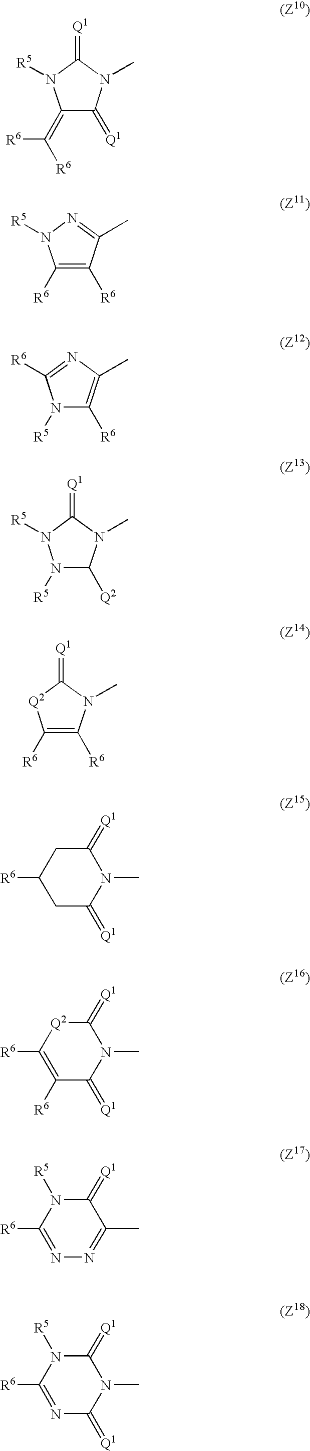 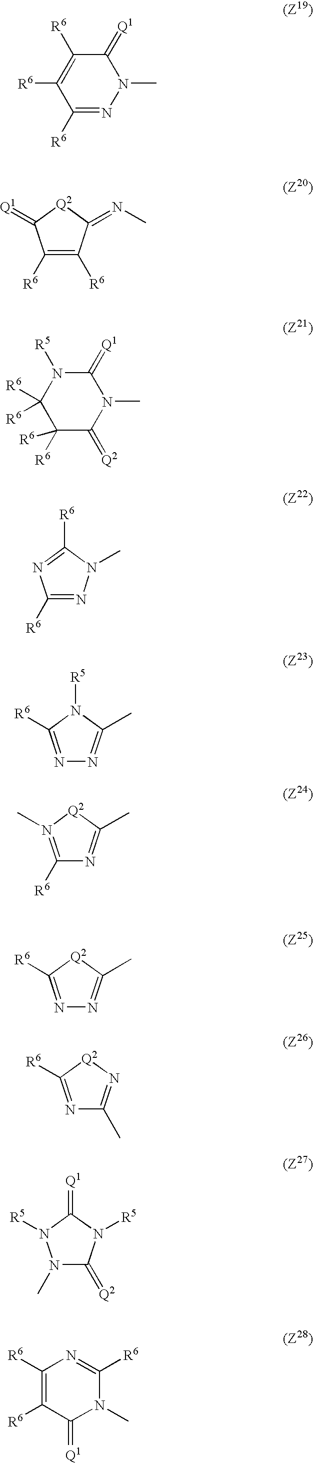 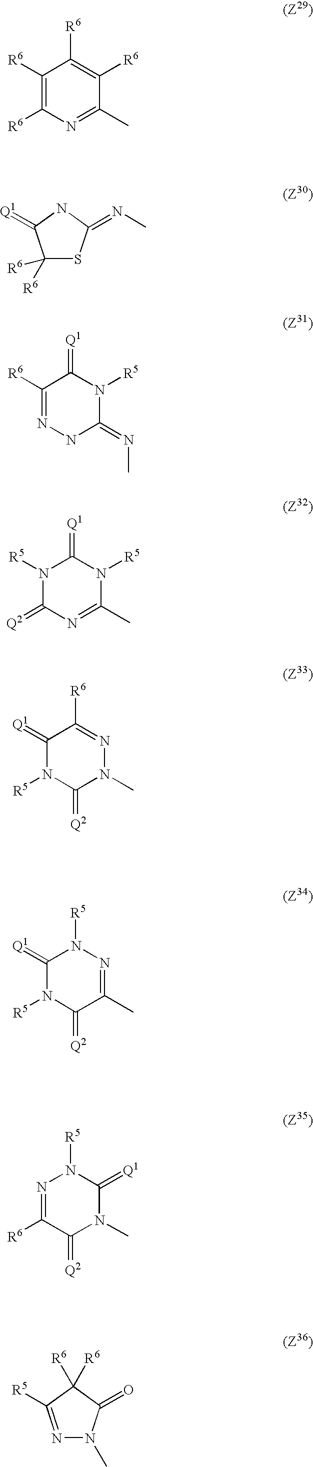 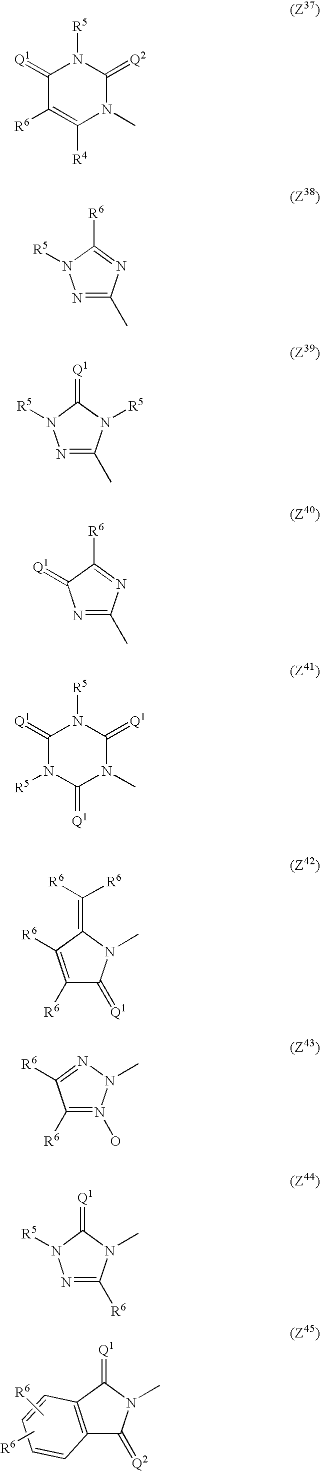 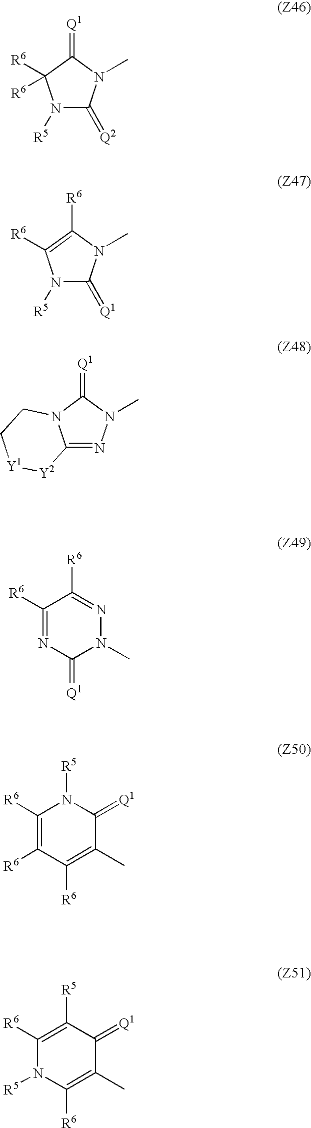
Q¹ preferably represents O (oxygen).
Q² preferably represents O (oxygen).
R⁵ preferably represents hydrogen, hydroxyl, amino, cyano, or represents in each case optionally cyano-, halogen- or C₁-C₄-alkoxy-substituted alkyl, alkoxy or alkoxycarbonyl having in each case 1 to 5 carbon atoms in the alkyl groups, represents in each case optionally cyano-, halogen- or C₁-C₄-alkoxy-carbonyl-substituted alkenyl or alkynyl having in each case 2 to 5 carbon atoms, represents in each case optionally cyano-, halogen- or C₁-C₃-alkyl-substituted cycloalkyl or cycloalkylalkyl having in each case 3 to 6 carbon atoms in the cycloalkyl group and, if appropriate, 1 to 3 carbon atoms in the alkyl moiety, or represents in each case optionally cyano-, nitro-, halogen-, C₁-C₄-alkyl-, C₁-C₄-haloalkyl-, C₁-C₄-alkoxy- or C₁-C₄-haloalkoxy-substituted phenyl or phenyl-C₁-C₃-alkyl.
R⁶ preferably represents hydrogen, amino, nitro, cyano, carboxyl, carbamoyl, thiocarbamoyl, halogen, represents in each case optionally cyano-, halogen- or C₁-C₄-alkoxy-substituted alkyl, alkoxy, alkoxycarbonyl, alkylthio, alkylsulfinyl, alkylsulfonyl, alkylsulfonyloxy, alkylamino or dialkylamino having in each case 1 to 5 carbon atoms in the alkyl groups, represents in each case optionally cyano- or halogen-substituted alkenyl, alkynyl, alkenyloxy, alkynyloxy, alkenylthio or alkynylthio having in each case 2 to 5 carbon atoms, or represents in each case optionally cyano-, halogen- or C₁-C₄-alkyl-substituted cycloalkyl or cycloalkylalkyl having in each case 3 to 6 carbon atoms in the cycloalkyl group and, if appropriate, 1 to 3 carbon atoms in the alkyl moiety.
   Two adjacent radicals—R⁵ and R⁵, R⁶ and R⁶ or R⁵ and R⁶—optionally together also particularly preferably represent alkanediyl or alkenediyl having in each case up to 6 carbon atoms and being in each case optionally substituted and/or optionally interrupted by O (oxygen), S (sulfur) or a grouping from the group consisting of —SO—, —SO₂—, —NH— or —N(C₁-C₄-alkyl)- at the beginning (or at the end) or within the hydrocarbon chain.
R¹ particularly preferably represents hydrogen, fluorine or chlorine.
R² particularly preferably represents nitro, cyano, thiocarbamoyl, or represents in each case optionally fluorine- and/or chlorine-substituted methyl, ethyl, n- or i-propyl, methoxy, ethoxy, n- or i-propoxy.
R³ and R⁴ together with the N atom to which they are attached particularly preferably represent monocyclic or bicyclic (including spirocyclic) heterocyclyl which has up to 9 carbon atoms, up to 4 N atoms and optionally additionally one O atom or one S atom, which optionally contains 1 or 2 oxo groupings (C═O), thioxo groupings (C═S) or sulfonyl groupings (SO₂) and which is optionally substituted by hydroxyl, amino, nitro, cyano, carbamoyl, thiocarbamoyl, formyl, fluorine, chlorine, bromine, methyl, ethyl, n- or i-propyl, n-, i-, s- or t-butyl, cyanomethyl, cyanoethyl, fluoromethyl, difluoromethyl, trifluoromethyl, fluoroethyl, difluoroethyl, trifluoroethyl, tetrafluoroethyl, pentafluoroethyl, chloromethyl, dichloromethyl, trichloromethyl, chloroethyl, dichloroethyl, trichloroethyl, chlorofluoromethyl, chlorodifluoromethyl, fluorodichloromethyl, chlorofluoroethyl, chlorodifluoroethyl, fluorodichloroethyl, chlorotrifluoroethyl, methoxymethyl, ethoxymethyl, methoxyethyl, ethoxyethyl, acetylmethyl, propionylmethyl, n- or i-butyroylmethyl, methoxycarbonylmethyl, ethoxycarbonylmethyl, n- or i-propoxycarbonylmethyl, methoxycarbonylethyl, ethoxycarbonylethyl, n- or i-propoxycarbonylethyl, methoxy, ethoxy, n- or i-propoxy, n-, i-, s- or t-butoxy, fluoromethoxy, difluoromethoxy, trifluoromethoxy, chlorodifluoromethoxy, fluoroethoxy, chloroethoxy, difluoroethoxy, dichloroethoxy, chlorofluoroethoxy, chlorodifluoroethoxy, trifluoroethoxy, methylthio, ethylthio, n- or i-propylthio, n-, i-, s- or t-butylthio, difluoromethylthio, trifluoromethylthio, chlorodifluoromethylthio, fluoroethylthio, chloroethylthio, difluoroethylthio, dichloroethylthio, chlorofluoroethylthio, chlorodifluoroethylthio, trifluoroethylthio, chlorodifluoroethylthio, methylsulfinyl, ethylsulfinyl, propylsulfinyl, trifluoromethylsulfinyl, fluoroethylsulfinyl, chloroethylsulfinyl, chlorofluoroethylsulfinyl, difluoroethylsulfinyl, chlorodifluoroethylsulfinyl, trifluoroethylsulfinyl, methylsulfonyl, ethylsulfonyl, trifluoromethylsulfonyl, acetyl, propionyl, n- or i-butyroyl, chloroacetyl, dichloroacetyl, trichloroacetyl, difluoroacetyl, trifluoroacetyl, methoxycarbonyl, ethoxycarbonyl, n- or i-propoxycarbonyl, n-, i-, s- or t-butoxycarbonyl, chloroethoxycarbonyl, fluoroethoxycarbonyl, methylaminocarbonyl, ethylaminocarbonyl, n- or i-propylaminocarbonyl, dimethylaminocarbonyl, diethylaminocarbonyl, dimethylaminosulfonyl, diethylaminosulfonyl, methylenedioxy, ethylenedioxy, difluoromethylenedioxy, difluoroethylenedioxy, trifluoroethylenedioxy, tetrafluoroethylenedioxy, chlorodifluoroethylenedioxy, cyclopropyl, cyclobutyl, cyclopentyl or cyclohexyl.
Z particularly preferably represents one of the heterocyclic groupings (Z¹), (Z²), (Z³), (Z¹¹), (Z¹³) or (Z⁴⁶) below 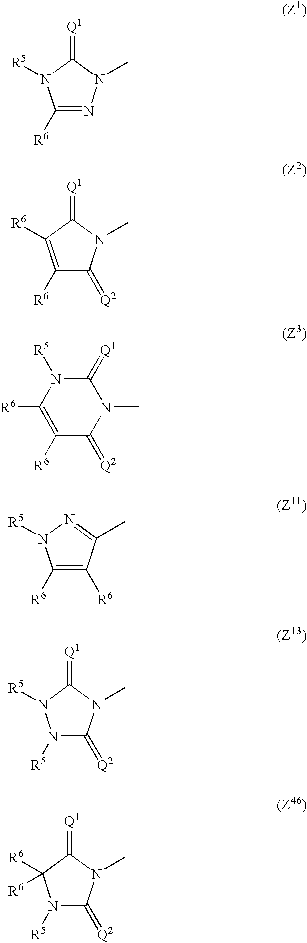
R⁵ particularly preferably represents hydrogen, hydroxyl, amino, cyano, or represents in each case optionally cyano-, fluorine-, chlorine-, bromine-, methoxy-, ethoxy-, n- or i-propoxy-substituted methyl, ethyl, n- or i-propyl, n-, i-, s- or t-butyl, methoxy, ethoxy, n- or i-propoxy, n-, i-, s- or t-butoxy, methoxycarbonyl, ethoxycarbonyl, n- or i-propoxycarbonyl, n-, i-, s- or t-butoxycarbonyl, represents in each case optionally cyano-, fluorine-, chlorine-, bromine-, methoxycarbonyl-, ethoxycarbonyl-, n- or i-propoxycarbonyl-, n-, i-, s- or t-butoxycarbonyl-substituted ethenyl, propenyl, butenyl, ethynyl, propynyl or butynyl, represents in each case optionally cyano-, fluorine-, chlorine-, bromine-, methyl- or ethyl-substituted cyclopropyl, cyclobutyl, cyclopentyl, cyclohexyl, cyclopropylmethyl, cyclobutylmethyl, cyclopentylmethyl or cyclohexylmethyl, or represents in each case optionally cyano-, nitro-, fluorine-, chlorine-, bromine-, iodine-, methyl-, ethyl-, n- or i-propyl-, n-, i-, s- or t-butyl-, fluoromethyl-, chloromethyl-, difluoromethyl-, dichloromethyl-, trifluoromethyl-, trichloromethyl-, fluorodichloromethyl-, methoxy-, ethoxy-, n- or i-propoxy-, n-, i-, s- or t-butoxy-, fluoromethoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trifluoroethoxy- or chlorodifluoroethoxy-substituted phenyl, benzyl or phenylethyl.
R⁶ particularly preferably represents hydrogen, amino, nitro, cyano, carboxyl, carbamoyl, thiocarbamoyl, fluorine, chlorine, bromine, iodine, represents in each case optionally cyano-, fluorine-, chlorine-, methoxy-, ethoxy-, n- or i-propoxy-substituted methyl, ethyl, n- or i-propyl, n-, i-, s- or t-butyl, methoxy, ethoxy, n- or i-propoxy, n-, i-, s- or t-butoxy, methoxycarbonyl, ethoxycarbonyl, n- or i-propoxycarbonyl, n-, i-, s- or t-butoxycarbonyl, methylthio, ethylthio, n- or i-propylthio, n-, i-, s- or t-butylthio, methylsulfinyl, ethylsulfinyl, propylsulfinyl, methylsulfonyl, ethylsulfonyl, methylsulfonyloxy, ethylsulfonyloxy, methylamino, ethylamino, n- or i-propylamino, n-, i-, s- or t-butylamino, dimethylamino or diethylamino, or represents in each case optionally cyano-, fluorine-, chlorine- or bromine-substituted ethenyl, propenyl, butenyl, pentenyl, ethynyl, propynyl, butynyl, pentynyl, propenyloxy, butenyloxy, pentenyloxy, propynyloxy, butynyloxy, pentynyloxy, propenylthio, butenylthio, pentenylthio, propynylthio, butynylthio or pentynylthio, or represents in each case optionally cyano-, fluorine-, chlorine-, bromine-, methyl-, ethyl-, n- or i-propyl-substituted cyclopropyl, cyclobutyl, cyclopentyl, cyclohexyl, cyclopropylmethyl, cyclobutylmethyl, cyclopentylmethyl or cyclohexylmethyl.
   Two adjacent radicals—R⁵ and R^{5,} R⁶ and R⁶ or R⁵ and R⁶—optionally together also particularly preferably represent alkanediyl or alkenediyl having in each case up to 6 carbon atoms and being in each case optionally substituted and/or optionally interrupted by O (oxygen), S (sulfur) or a grouping from the group consisting of —SO—, —SO₂—, —NH—or —N(methyl)- at the beginning (or at the end) or within the hydrocarbon chain.
R¹ very particularly preferably represents fluorine or chlorine.
R² very particularly preferably represents cyano or nitro.
R³ and R⁴ together with the N atom to which they are attached very particularly preferably represent heterocyclyl from the group consisting of pyrrolyl, pyrrolinyl, pyrrolidinyl, pyrazolyl, piperidinyl, morpholinyl, thiomorpholinyl, piperazinyl, 2,4-dioxoimidazolidinyl, 2,4-dioxoperhydropyrimidinyl, 2,4-di-oxoperhydrooxazolyl or 1,4-dioxoperhydrothiazolyl which is in each case optionally substituted by hydroxyl, nitro, cyano, carbamoyl, thiocarbamoyl, formyl, fluorine, chlorine, bromine, methyl, ethyl, n- or i-propyl, n-, i-, s- or t-butyl, cyanomethyl, cyanoethyl, fluoromethyl, difluoromethyl, trifluoromethyl, fluoroethyl, difluoroethyl, trifluoroethyl, tetrafluoroethyl, pentafluoroethyl, chloromethyl, dichloromethyl, trichloromethyl, chloroethyl, dichloroethyl, trichloroethyl, chlorofluoromethyl, chlorodifluoromethyl, fluorodichloromethyl, chlorofluoroethyl, chlorodifluoroethyl, fluorodichloroethyl, chlorotrifluoroethyl, methoxymethyl, ethoxymethyl, methoxyethyl, ethoxyethyl, acetylmethyl, propionylmethyl, n- or i-butyroylmethyl, methoxycarbonylmethyl, ethoxycarbonylmethyl, n- or i-propoxycarbonylmethyl, methoxycarbonylethyl, ethoxycarbonylethyl, n- or i-propoxycarbonylethyl, methoxy, ethoxy, n- or i-propoxy, n-, i-, s- or t-butoxy, fluoromethoxy, difluoromethoxy, trifluoromethoxy, chlorodifluoromethoxy, fluoroethoxy, chloroethoxy, difluoroethoxy, dichloroethoxy, chlorofluoroethoxy, chlorodifluoroethoxy, trifluoroethoxy, methylthio, ethylthio, n- or i-propylthio, n-, i-, s- or t-butylthio, difluoromethylthio, trifluoromethylthio, chlorodifluoromethylthio, fluoroethylthio, chloroethylthio, difluoroethylthio, dichloroethylthio, chlorofluoroethylthio, chlorodifluoroethylthio, trifluoroethylthio, chlorodifluoroethylthio, methylsulfinyl, ethylsulfinyl, propylsulfinyl, trifluoromethylsulfinyl, fluoroethylsulfinyl, chloroethylsulfinyl, chlorofluoroethylsulfinyl, difluoroethylsulfinyl, chlorodifluoroethylsulfinyl, trifluoroethylsulfinyl, methylsulfonyl, ethylsulfonyl, trifluoromethylsulfonyl, acetyl, propionyl, n- or i-butyroyl, chloroacetyl, dichloroacetyl, trichloroacetyl, difluoroacetyl, trifluoroacetyl, methoxycarbonyl, ethoxycarbonyl, n- or i-propoxycarbonyl, n-, i-, s- or t-butoxycarbonyl, chloroethoxycarbonyl, fluoroethoxycarbonyl, methylaminocarbonyl, ethylaminocarbonyl, n- or i-propylaminocarbonyl, dimethylaminocarbonyl, diethylaminocarbonyl, dimethylaminosulfonyl, diethylaminosulfonyl, methylenedioxy, ethylenedioxy, difluoromethylenedioxy, difluoroethylenedioxy, trifluoroethylenedioxy, tetrafluoroethylenedioxy, chlorodifluoroethylenedioxy, cyclopropyl, cyclobutyl, cyclopentyl or cyclohexyl, and which is optionally benzo-fused or which is optionally linked to propane-1,3-diyl or butane-1,4-diyl.

Two adjacent radicals—R⁵ and R⁵, R⁶ and R⁶ or R⁵ and R⁶—optionally together very particularly preferably represent alkanediyl having 4 carbon atoms.
R¹ especially preferably represents fluorine.
R³ and R⁴ together with the N atom to which they are attached especially preferably represent one of the heterocycles below 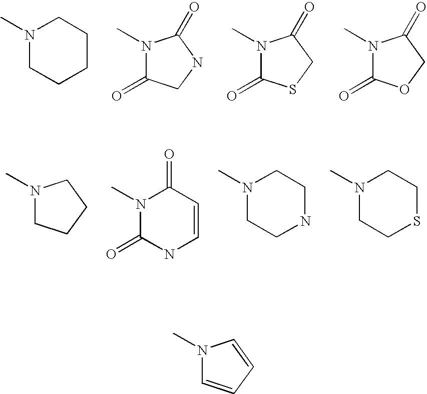
   which is in each case optionally substituted by hydroxyl, nitro, cyano, carbamoyl, thiocarbamoyl, formyl, fluorine, chlorine, bromine, methyl, ethyl, n- or i-propyl, n-, i-, s- or t-butyl, cyanomethyl, cyanoethyl, fluoromethyl, di-fluoromethyl, trifluoromethyl, fluoroethyl, difluoroethyl, trifluoroethyl, tetra-fluoroethyl, pentafluoroethyl, chloromethyl, dichloromethyl, trichloromethyl, chloroethyl, dichloroethyl, trichloroethyl, chlorofluoromethyl, chlorodifluoro-methyl, fluorodichloromethyl, chlorofluoroethyl, chlorodifluoroethyl, fluoro-dichloroethyl, chlorotrifluoroethyl, methoxymethyl, ethoxymethyl, methoxy-ethyl, ethoxyethyl, acetylmethyl, propionylmethyl, n- or i-butyroylmethyl, methoxycarbonylmethyl, ethoxycarbonylmethyl, n- or i-propoxycarbonyl-methyl, methoxycarbonylethyl, ethoxycarbonylethyl, n- or i-propoxycarbonyl-ethyl, methoxy, ethoxy, n- or i-propoxy, n-, i-, s- or t-butoxy, fluoromethoxy, difluoromethoxy, trifluoromethoxy, chlorodifluoromethoxy, fluoroethoxy, chloroethoxy, difluoroethoxy, dichloroethoxy, chlorofluoroethoxy, chloro-difluoroethoxy, trifluoroethoxy, methylthio, ethylthio, n- or i-propylthio, n-, i-, s- or t-butylthio, difluoromethylthio, trifluoromethylthio, chlorodifluoromethylthio, fluoroethylthio, chloroethylthio, difluoroethylthio, dichloroethylthio, chlorofluoroethylthio, chlorodifluoroethylthio, trifluoroethylthio, chlorodifluoroethylthio, methylsulfinyl, ethylsulfinyl, propylsulfinyl, tri-fluoromethylsulfinyl, fluoroethylsulfinyl, chloroethylsulfinyl, chloro-fluoroethylsulfinyl, difluoroethylsulfinyl, chlorodifluoroethylsulfinyl, tri-fluoroethylsulfinyl, methylsulfonyl, ethylsulfonyl, trifluoromethylsulfonyl, acetyl, propionyl, n- or i-butyroyl, chloroacetyl, dichloroacetyl, trichloroacetyl, difluoroacetyl, trifluoroacetyl, methoxycarbonyl, ethoxycarbonyl, n- or i-propoxycarbonyl, n-, i-, s- or t-butoxycarbonyl, chloroethoxycarbonyl, fluoroethoxycarbonyl, methylaminocarbonyl, ethylaminocarbonyl, n- or i-propylaminocarbonyl, dimethylaminocarbonyl, diethylaminocarbonyl, dimethylaminosulfonyl, diethylaminosulfonyl, methylenedioxy, ethylenedioxy, difluoromethylenedioxy, difluoroethylenedioxy, trifluoroethylenedioxy, tetrafluoroethylenedioxy, chlorodifluoroethylenedioxy, cyclopropyl, cyclobutyl, cyclopentyl or cyclohexyl, and which is optionally benzo-fused or which is optionally linked to propane-1,3-diyl or butane-1,4-diyl.

In a very particularly preferred group of the compounds of the general formula (I) according to the invention,
R¹ represents fluorine or chlorine,
R² represents cyano, thiocarbamoyl or trifluoromethyl,
R³ and R⁴ together with the N atom to which they are attached represent heterocyclyl from the group consisting of pyrrolyl, pyrrolinyl, pyrrolidinyl, pyrazolyl, piperidinyl, morpholinyl, thiomorpholinyl, piperazinyl, 2,4-dioxo-imidazolidinyl, 2,4-dioxoperhydropyrimidinyl, 2,4-dioxoperhydrooxazolyl or 1,4-dioxoperhydrothiazolyl which is in each case optionally substituted by hydroxyl, nitro, cyano, carbamoyl, thiocarbamoyl, formyl, fluorine, chlorine, bromine, methyl, ethyl, n- or i-propyl, n-, i-, s- or t-butyl, cyanomethyl, cyanoethyl, fluoromethyl, difluoromethyl, trifluoromethyl, fluoroethyl, di-fluoroethyl, trifluoroethyl, tetrafluoroethyl, pentafluoroethyl, chloromethyl, dichloromethyl, trichloromethyl, chloroethyl, dichloroethyl, trichloroethyl, chlorofluoromethyl, chlorodifluoromethyl, fluorodichloromethyl, chloro-fluoroethyl, chlorodifluoroethyl, fluorodichloroethyl, chlorotrifluoroethyl, methoxymethyl, ethoxymethyl, methoxyethyl, ethoxyethyl, acetylmethyl, propionylmethyl, n- or i-butyroylmethyl, methoxycarbonylmethyl, ethoxy-carbonylmethyl, n- or i-propoxycarbonylmethyl, methoxycarbonylethyl, ethoxycarbonylethyl, n- or i-propoxycarbonylethyl, methoxy, ethoxy, n- or i-propoxy, n-, i-, s- or t-butoxy, fluoromethoxy, difluoromethoxy, trifluoro-methoxy, chlorodifluoromethoxy, fluoroethoxy, chloroethoxy, difluoroethoxy, dichloroethoxy, chlorofluoroethoxy, chlorodifluoroethoxy, trifluoroethoxy, methylthio, ethylthio, n- or i-propylthio, n-, i-, s- or t-butylthio, difluoro-methylthio, trifluoromethylthio, chlorodifluoromethylthio, fluoroethylthio, chloroethylthio, difluoroethylthio, dichloroethylthio, chlorofluoroethylthio, chlorodifluoroethylthio, trifluoroethylthio, chlorodifluoroethylthio, methyl-sulfinyl, ethylsulfinyl, propylsulfinyl, trifluoromethylsulfinyl, fluoroethylsulfinyl, chloroethylsulfinyl, chlorofluoroethylsulfinyl, difluoroethylsulfinyl, chlorodifluoroethylsulfinyl, trifluoroethylsulfinyl, methylsulfonyl, ethylsulfonyl, trifluoromethylsulfonyl, acetyl, propionyl, n- or i-butyroyl, chloroacetyl, dichloroacetyl, trichloroacetyl, difluoroacetyl, trifluoroacetyl, methoxycarbonyl, ethoxycarbonyl, n- or i-propoxycarbonyl, n-, i-, s- or t-butoxycarbonyl, chloroethoxycarbonyl, fluoroethoxycarbonyl, methylaminocarbonyl, ethylaminocarbonyl, n- or i-propylaminocarbonyl, dimethylaminocarbonyl, diethylaminocarbonyl, dimethylaminosulfonyl, diethylaminosulfonyl, methylenedioxy, ethylenedioxy, difluoromethylenedioxy, difluoroethylenedioxy, trifluoroethylenedioxy, tetrafluoroethylenedioxy, chlorodifluoroethylenedioxy, cyclopropyl, cyclobutyl, cyclopentyl or cyclohexyl and which is optionally benzo-fused or which is optionally linked to propane-1,3-diyl or butane-1,4-diyl, and
Z particularly preferably represents one of the heterocyclic groupings below 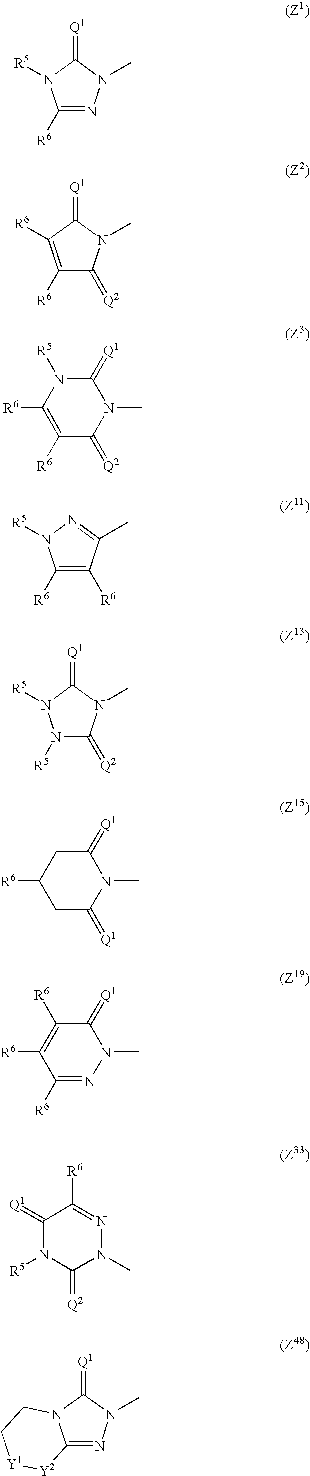
   where
Q¹ represents O (oxygen),
Q² represents O (oxygen),
R⁵ represents hydrogen, hydroxyl, amino, cyano, or represents in each case optionally cyano-, fluorine-, chlorine-, bromine-, methoxy-, ethoxy-, n- or i-propoxy-substituted methyl, ethyl, n- or i-propyl, methoxy, ethoxy, n- or i-propoxy, methoxycarbonyl, ethoxycarbonyl, n- or i-propoxycarbonyl, represents in each case optionally cyano-, fluorine-, chlorine-, bromine-, methoxycarbonyl-, ethoxycarbonyl-, n- or i-propoxycarbonyl-substituted ethenyl, propenyl, ethynyl or propynyl, represents in each case optionally cyano-, fluorine-, chlorine-, bromine-, methyl- or ethyl-substituted cyclopropyl, cyclobutyl, cyclopentyl, cyclohexyl, cyclopropylmethyl, cyclobutylmethyl, cyclopentylmethyl or cyclohexylmethyl, or represents in each case optionally cyano-, nitro-, fluorine-, chlorine-, bromine-, iodine-, methyl-, ethyl-, n- or i-propyl-, n-, i-, s- or t-butyl-, fluoromethyl-, chloromethyl-, difluoromethyl-, dichloromethyl-, trifluoromethyl-, trichloromethyl-, fluorodichloromethyl-, methoxy-, ethoxy-, n- or i-propoxy-, fluoromethoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trifluoroethoxy- or chlorodifluoroethoxy-substituted phenyl or benzyl, and
R⁶ represents hydrogen, amino, cyano, carboxyl, carbamoyl, thiocarbamoyl, fluorine, chlorine, bromine, represents in each case optionally cyano-, fluorine-, chlorine-, methoxy- or ethoxy-substituted methyl, ethyl, n- or i-propyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl, ethylsulfonyl, methylsulfonyloxy, ethylsulfonyloxy, methylamino, ethylamino, n- or i-propylamino, di-methylamino or diethylamino, represents in each case optionally cyano-, fluorine-, chlorine- or bromine-substituted ethenyl, propenyl, butenyl, ethynyl, propynyl, butynyl, propenyloxy, butenyloxy, propynyloxy, butynyloxy, propenylthio, butenylthio, propynylthio or butynylthio, or represents in each case optionally cyano-, fluorine-, chlorine-, bromine-, methyl- or ethyl-substituted cyclopropyl, cyclobutyl, cyclopentyl, cyclohexyl, cyclopropyl-methyl, cyclobutylmethyl, cyclopentylmethyl or cyclohexylmethyl,
   where optionally two adjacent radicals—R⁵ and R⁵, R⁶ and R⁶ or R⁵ and R⁶—together represent alkanediyl or alkenediyl having in each case up to 6 carbon atoms and being in each case optionally substituted and/or optionally interrupted by O (oxygen), S (sulfur) or a grouping from the group consisting of —SO—, —SO₂—, —NH— or —N(methyl)- at the beginning (or at the end) or within the hydrocarbon chain.

The general or preferred radical definitions listed above apply both to the end products of the formula (I) and, correspondingly, to the starting materials or intermediates required in each case for the preparation. These radical definitions can be combined with one another as desired, i.e. including combinations between the given preferred ranges.

The novel substituted N-aryl nitrogen heterocycles of the general formula (I) have interesting biological properties. In particular, they have strong herbicidal and arthropodicidal activity.

The novel substituted N-aryl nitrogen heterocycles of the general formula (I) are obtained when
(a) N-aryl nitrogen heterocycles of the general formula (II) 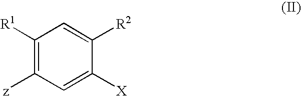
   in which
R¹, R² and Z are as defined above and
X represents halogen
are reacted with nitrogen compounds of the general formula (III) 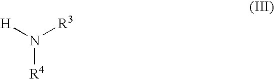
   in which
R³ and R⁴ are as defined above,
if appropriate in the presence of one or more diluents and if appropriate in the presence of one or more reaction auxiliaries, or when
(b) N-aryl nitrogen heterocycles of the general formula (IV) 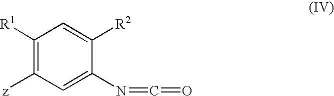
   in which
R¹, R² and Z are as defined above
are reacted with alkyl carboxylates which contain nucleophilic groupings in the alpha position,
if appropriate in the presence of one or more diluents and if appropriate in the presence of one or more reaction auxiliaries,
and the resulting compounds of the formula (I) are, if appropriate, converted by customary methods into other compounds of the formula (I).

Using, for example, 3-(4-cyano-2,5-difluorophenyl)-6-trifluoromethyl-1H-pyrimidine-2,4-dione and pyrazole as starting materials, the course of the reaction in the process (a) according to the invention can be illustrated by the formula scheme below:

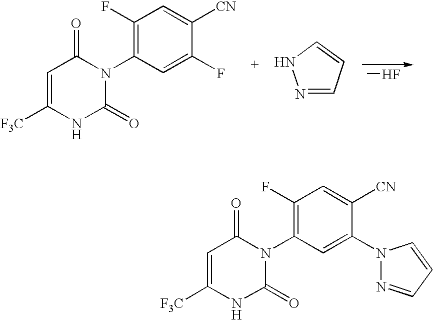

Using, for example, 3-(4-cyano-2-chloro-5-isocyanatophenyl)-1-methyl-6-trifluoro-methyl-1H-pyrimidine-2,4-dione and ethyl hydroxyacetate as starting materials, the course of the reaction in the process (b) according to the invention can be illustrated by the formula scheme below:

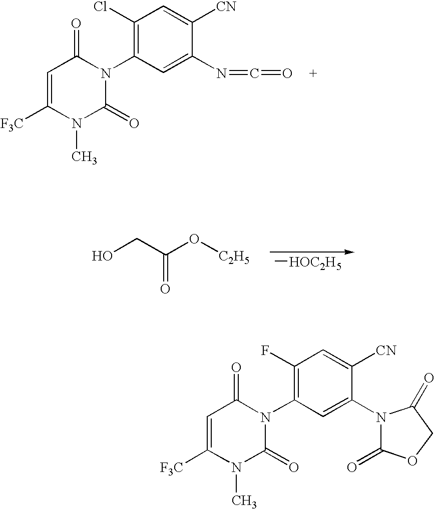

The formula (II) provides a general definition of the N-aryl nitrogen heterocycles to be used as starting materials in process (a) according to the invention for preparing compounds of the general formula (I). In the general formula (II), R¹, R² and Z preferably or in particular have those meanings which have already been mentioned above, in connection with the description of the compounds of the general formula (I) according to the invention, as being preferred, particularly preferred or very particularly preferred for R¹, R² and Z; X preferably represents fluorine, chlorine or bromine, in particular fluorine or chlorine.

The starting materials of the general formula (II) are known and/or can be prepared by processes known per se (cf. EP 648 749 A1).

The formula (III) provides a general definition of the nitrogen compounds further to be used as starting materials in process (a) according to the invention for preparing compounds of the general formula (I). In the general formula (III), R³ and R⁴ preferably have that meaning which has already been given above, in connection with the description of the compounds of the general formula (I) according to the invention, as being preferred, particularly preferred or very particularly preferred for R³ and R⁴.

The starting materials of the general formula (III) are known organic chemicals for synthesis.

The formula (IV) provides a general definition of the N-aryl nitrogen heterocycles to be used as starting materials in process (b) according to the invention for preparing compounds of the general formula (I). In the general formula (IV), R¹, R² and Z preferably have those meanings which have already been given above, in connection with the description of the compounds of the general formula (I) according to the invention, as being preferred, particularly preferred or very particularly preferred for R¹, R² and Z.

The starting materials of the general formula (IV) and routes for their preparation are described in DE 102 19 434.

The N-aryl nitrogen heterocycles of the general formula (IV) are obtained when aryl-amines of the general formula (V) 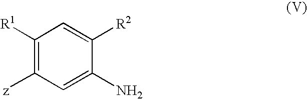
in which
R¹, R² and Z are as defined above,
are reacted with phosgene (or diphosgene), if appropriate in the presence of a reaction auxiliary, such as, for example, diazabicyclo[2.2.2]octane, and in the presence of a diluent, such as, for example, acetone, toluene, xylene or chloro-benzene, at temperatures between 0° C. and 150° C., and the volatile components are distilled off under reduced pressure after the reaction has ended (cf. the Preparation Examples).

For carrying out process (b) according to the invention, the further reaction components used are alkyl carboxylates which contain nucleophilic groupings in the alpha position.

These preferably include methyl and ethyl hydroxyacetate and hydroxypropionate, methyl and ethyl mercaptoacetate and mercaptopropionate, methyl and ethyl aminoacetate and aminopropionate, methyl and ethyl methylaminoacetate, ethylaminoacetate and n- and i-propylaminoacetate and cyclopropylaminoacetate.

These starting materials are known organic chemicals for synthesis.

The processes (a) and (b) according to the invention for preparing the compounds of the general formula (I) are preferably carried out using one or more reaction auxiliaries. Suitable reaction auxiliaries are, in general, the customary inorganic or organic bases or acid acceptors. These preferably include alkali metal or alkaline earth metal acetates, amides, carbonates, bicarbonates, hydrides, hydroxides or alkoxides, such as, for example, sodium acetate, potassium acetate or calcium acetate, lithium amide, sodium amide, potassium amide or calcium amide, sodium carbonate, potassium carbonate or calcium carbonate, sodium bicarbonate, potassium bicarbonate or calcium bicarbonate, lithium hydride, sodium hydride, potassium hydride or calcium hydride, lithium hydroxide, sodium hydroxide, potassium hydroxide or calcium hydroxide, sodium methoxide, ethoxide, n- or i-propoxide, n-, i-, s- or t-butoxide or potassium methoxide, ethoxide, n- or i-propoxide, n-, i-, s- or t-butoxide; furthermore also basic nitrogen compounds, such as, for example, trimethylamine, triethylamine, tripropylamine, tributylamine, ethyldiisopropylamine, N,N-dimethylcyclohexylamine, dicyclohexylamine, ethyidicyclohexylamine, N,N-dimethylaniline, N,N-dimethylbenzylamine, pyridine, 2-methyl-, 3-methyl-, 4-methyl-, 2,4-dimethyl-, 2,6-dimethyl-, 3,4-dimethyl- and 3,5-dimethylpyridine, 5-ethyl-2-methylpyridine, 4-dimethylaminopyridine, N-methylpiperidine, 1,4-diazabicyclo[2.2.2]-octane (DABCO), 1,5-diazabicyclo[4.3.0]non-5-ene (DBN), or 1,8-diazabicyclo[5.4.0]undec-7-ene (DBU).

The processes (a) and (b) according to the invention for preparing the compounds of the general formula (I) are preferably carried out using one or more diluents. Suitable diluents are especially inert organic solvents. These include in particular aliphatic, alicyclic or aromatic, optionally halogenated hydrocarbons, such as, for example, benzine, benzene, toluene, xylene, chlorobenzene, dichlorobenzene, petroleum ether, hexane, cyclohexane, dichloromethane, chloroform, carbon tetrachloride; ethers, such as diethyl ether, diisopropyl ether, dioxane, tetrahydrofuran or ethylene glycol dimethyl ether or ethylene glycol diethyl ether; ketones, such as acetone, butanone or methyl isobutyl ketone; nitriles, such as acetonitrile, propionitrile or butyronitrile; amides, such as N,N-dimethylformamide, N,N-dimethylacetamide, N-methylformanilide, N-methylpyrrolidone or hexamethylphosphoric triamide; esters, such as methyl acetate or ethyl acetate; sulfoxides, such as dimethyl sulfoxide.

When carrying out the processes (a) and (b) according to the invention, the reaction temperatures can be varied in a relatively wide range. In general, the processes are carried out at temperatures between −20° C. and +200° C., preferably between 0° C. and +180° C.

The processes according to the invention are generally carried out under atmospheric pressure. However, it is also possible to carry out the processes according to the invention under elevated or reduced pressure—in general between 0.1 bar and 10 bar.

For carrying out the processes according to the invention, the starting materials are generally employed in approximately equimolar amounts. However, it is also possible to use a relatively large excess of one of the components. The reaction is generally carried out in a suitable diluent in the presence of a reaction auxiliary and the reaction mixture is generally stirred at the required temperature for a number of hours. Work-up is carried out by customary methods (cf. the Preparation Examples).

The active compounds according to the invention can be used as defoliants, desiccants, haulm killers and, especially, as weedkillers. Weeds in the broadest sense are understood to mean all plants which grow in locations where they are undesired. Whether the substances according to the invention act as total or selective herbicides depends essentially on the amount used.

The active compounds according to the invention can be used, for example, in connection with the following plants:

Dicotyledonous weeds of the genera: Abutilon, Amaranthus, Ambrosia, Anoda, Anthemis, Aphanes, Atriplex, Bellis, Bidens, Capsella, Carduus, Cassia, Centaurea, Chenopodium, Cirsium, Convolvulus, Datura, Desmodium, Emex, Erysimum, Euphorbia, Galeopsis, Galinsoga, Galium, Hibiscus, Ipomoea, Kochia, Lamium, Lepidium, Lindernia, Matricaria, Mentha, Mercurialis, Mullugo, Myosotis, Papaver, Pharbitis, Plantago, Polygonum, Portulaca, Ranunculus, Raphanus, Rorippa, Rotala, Rumex, Salsola, Senecio, Sesbania, Sida, Sinapis, Solanum, Sonchus, Sphenoclea, Stellaria, Taraxacum, Thlaspi, Trifolium, Urtica, Veronica, Viola, Xanthium.

Dicotyledonous crops of the genera: Arachis, Beta, Brassica, Cucumis, Cucurbita, Helianthus, Daucus, Glycine, Gossypium, Ipomoea, Lactuca, Linum, Lycopersicon, Nicotiana, Phaseolus, Pisum, Solanum, Vicia.

Monocotyledonous weeds of the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagiftaria, Scirpus, Setaria, Sorghum.

Monocotyledonous crops of the genera: Allium, Ananas, Asparagus, Avena, Hordeum, Oryza, Panicum, Saccharum, Secale, Sorghum, Triticale, Triticum, Zea.

However, the use of the active compounds according to the invention is in no way restricted to these genera, but also extends in the same manner to other plants.

The active compounds according to the invention are suitable, depending on the concentration, for the total control of weeds, for example on industrial terrain and rail tracks, and on paths and areas with and without tree plantings. Similarly, the active compounds according to the invention can be employed for controlling weeds in perennial crops, for example forests, decorative tree plantings, orchards, vineyards, citrus groves, nut orchards, banana plantations, coffee plantations, tea plantations, rubber plantations, oil palm plantations, cocoa plantations, soft fruit plantings and hop fields, on lawns, turf and pastureland, and for the selective control of weeds in annual crops.

The compounds of the formula (I) according to the invention have strong herbicidal activity and a broad activity spectrum when used on the soil and on above-ground parts of plants. To a certain extent they are also suitable for the selective control of monocotyledonous and dicotyledonous weeds in monocotyledonous and dicotyledonous crops, both by the pre-emergence and by the post-emergence method.

At certain concentrations or application rates, the active compounds according to the invention can also be employed for controlling animal pests and fungal or bacterial plant diseases. If appropriate, they can also be used as intermediates or precursors for the synthesis of other active compounds.

All plants and plant parts can be treated in accordance with the invention. Plants are to be understood as meaning in the present context all plants and plant populations such as desired and undesired wild plants or crop plants (including naturally occurring crop plants). Crop plants can be plants which can be obtained by conventional plant breeding and optimization methods or by biotechnological and recombinant methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offsets and seeds.

Treatment according to the invention of the plants and plant parts with the active compounds is carried out directly or by allowing the compounds to act on the surroundings, environment or storage space by the customary treatment methods, for example by immersion, spraying, evaporation, fogging, scattering, painting on and, in the case of propagation material, in particular in the case of seeds, also by applying one or more coats.

The active compounds can be converted into the customary formulations such as solutions, emulsions, wettable powders, suspensions, powders, dusts, pastes, soluble powders, granules, suspension-emulsion concentrates, natural and synthetic materials impregnated with active compound, and microencapsulations in polymeric materials.

These formulations are produced in a known manner, for example by mixing the active compounds with extenders, that is liquid solvents and/or solid carriers, optionally with the use of surfactants, that is emulsifiers and/or dispersants, and/or foam formers.

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulfoxide, or else water.

Suitable solid carriers are: for example ammonium salts and ground natural minerals such as kaolins, clays, talc, chalk, quartz, attapulgite, montmorillonite or diatomaceous earth, and ground synthetic minerals such as finely divided silica, alumina and silicates; suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, corn cobs and tobacco stalks; suitable emulsifiers and/or foam formers are: for example nonionic and anionic emulsifiers such as polyoxyethylene fatty acid esters, polyoxyethylene fatty alcohol ethers, for example alkylaryl polyglycol ethers, alkylsulfonates, alkyl sulfates, arylsulfonates, or else protein hydrolysates; suitable dispersants are: for example lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc.

The formulations generally comprise between 0.1 and 95% by weight of active compound, preferably between 0.5 and 90%.

For controlling weeds, the active compounds according to the invention, as such or in their formulations, can also be used as mixtures with known herbicides and/or substances which improve the compatibility with crop plants (“safeners”), finished formulations or tank mixes being possible. Also possible are thus mixtures with weed-killers comprising one or more known herbicides and a safener.

Possible components for the mixtures are known herbicides, for example

acetochlor, acifluorfen (-sodium), aclonifen, alachlor, alloxydim (-sodium), ametryne, amicarbazone, amidochlor, amidosulfuron, anilofos, asulam, atrazine, azafenidin, azimsulfuron, beflubutamid, benazolin (-ethyl), benfuresate, bensulfuron (-methyl), bentazon, benzfendizone, benzobicyclon, benzofenap, benzoylprop (-ethyl), bialaphos, bifenox, bispyribac (-sodium), bromobutide, bromofenoxim, bromoxynil, butachlor, butafenacil (-allyl), butroxydim, butylate, cafenstrole, caloxydim, carbetamide, carfentrazone (-ethyl), chlomethoxyfen, chloramben, chloridazon, chlorimuron (-ethyl), chlornitrofen, chlorsulfuron, chlortoluron, cinidon (-ethyl), cinmethylin, cinosulfuron, clefoxydim, clethodim, clodinafop (-propargyl), clomazone, clomeprop, clopyralid, clopyrasulfuron (-methyl), cloransulam (-methyl), cumyluron, cyanazine, cybutryne, cycloate, cyclosulfamuron, cycloxydim, cyhalofop (-butyl), 2,4-D, 2,4-DB, desmedipham, diallate, dicamba, dichlorprop (—P), diclofop (-methyl), diclosulam, diethatyl (-ethyl), difenzoquat, diflufenican, diflufenzopyr, dimefuron, dimepiperate, dimethachlor, dimethametryn, dimethenamid, dimexyflam, dinitramine, diphenamid, diquat, dithiopyr, diuron, dymron, epropodan, EPTC, esprocarb, ethalfluralin, ethametsulfuron (-methyl), ethofumesate, ethoxyfen, ethoxysulfuron, etobenzanid, fenoxaprop (—P-ethyl), fentrazamide, flamprop (-isopropyl, -isopropyl-L, -methyl), flazasulfuron, florasulam, fluazifop (—P-butyl), fluazolate, flucarbazone (-sodium), flufenacet, flufenpyr, flumetsulam, flumiclorac (-pentyl), flumioxazin, flumipropyn, flumetsulam, fluometuron, fluorochloridone, fluoroglycofen (-ethyl), flupoxam, flupropacil, flurpyrsulfuron (-methyl, -sodium), flurenol (-butyl), fluridone, fluroxypyr (-butoxypropyl, -meptyl), flurprimidol, flurtamone, fluthiacet (-methyl), fluthiamide, fomesafen, foramsulfuron, glufosinate (-ammonium), glyphosate (-isopropylammonium), halosafen, haloxyfop (-ethoxyethyl, -P-methyl), hexazinone, imazamethabenz (-methyl), imazamethapyr, imazamox, imazapic, imazapyr, imazaquin, imazethapyr, imazosulfuron, iodosulfuron (-methyl, -sodium), ioxynil, isopropalin, isoproturon, isouron, isoxaben, isoxachlortole, isoxaflutole, isoxapyrifop, ketospiradox, lactofen, lenacil, linuron, MCPA, mecoprop, mefenacet, mesotrione, metamitron, metazachlor, methabenzthiazuron, metobenzuron, metobromuron, (alpha-) metolachlor, metosulam, metoxuron, metribuzin, metsulfuron (-methyl), molinate, monolinuron, naproanilide, napropamide, neburon, nicosulfuron, norflurazon, orbencarb, oryzalin, oxadiargyl, oxadiazon, oxasulfuron, oxaziclomefone, oxyfluorfen, paraquat, pelargonic acid, pendimethalin, pendralin, penoxysulam, pentoxazone, pethoxamid, phenmedipham, picolinafen, piperophos, pretilachlor, primisulfuron (-methyl), profluazol, profoxydim, prometryn, propachlor, propanil, propaquizafop, propisochlor, propoxycarbazone (-sodium), propyzamide, prosulfocarb, prosulfuron, pyraflufen (-ethyl), pyrazogyl, pyrazolate, pyrazosulfuron (-ethyl), pyrazoxyfen, pyribenzoxim, pyributicarb, pyridate, pyridatol, pyriftalid, pyriminobac (-methyl), pyrithiobac (-sodium), quinchlorac, quinmerac, quinoclamine, quizalofop (—P-ethyl, —P-tefuryl), rimsulfuron, sethoxydim, simazine, simetryn, sulcotrione, sulfentrazone, sulfometuron (-methyl), sulfosate, sulfosulfuron, tebutam, tebuthiuron, tepraloxydim, terbuthylazine, terbutryn, thenylchlor, thiafluamide, thiazopyr, thidiazimin, thifensulfuron (-methyl), thiobencarb, tiocarbazil, tralkoxydim, triallate, triasulfuron, tribenuron (-methyl), triclopyr, tridiphane, trifluralin, trifloxysulfuron, triflusulfuron (-methyl), tritosulfuron.

Furthermore suitable for the mixtures are known safeners, for example:

AD-67, BAS-145138, benoxacor, cloquintocet (-mexyl), cyometrinil, 2,4-D, DKA-24, dichlormid, dymron, fenclorim, fenchlorazol (-ethyl), flurazole, fluxofenim, furilazole, isoxadifen (-ethyl), MCPA, mecoprop (—P), mefenpyr (-diethyl), MG-191, oxabetrinil, PPG-1292, R-29148.

A mixture with other known active compounds, such as fungicides, insecticides, acaricides, nematicides, bird repellents, plant nutrients and agents which improve soil structure, is also possible.

The active compounds can be used as such, in the form of their formulations or in the use forms prepared therefrom by further dilution, such as ready-to-use solutions, suspensions, emulsions, powders, pastes and granules. They are applied in a customary manner, for example by watering, spraying, atomizing or broadcasting.

The active compounds according to the invention can be applied both before and after emergence of the plants. They can also be incorporated into the soil before sowing.

The amount of active compound used can vary within a relatively wide range. It depends essentially on the nature of the desired effect. In general, the amounts used are between 1 g and 10 kg of active compound per hectare of soil surface, preferably between 5 g and 5 kg per ha.

As already mentioned above, it is possible to treat all plants and their parts according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering, if appropriate in combination with conventional methods (Genetically Modified Organisms), and parts thereof are treated. The term “parts” or “parts of plants” or “plant parts” has been explained above.

Particularly preferably, plants of the plant cultivars which are in each case commercially available or in use are treated according to the invention. Plant cultivars are understood as meaning plants with certain properties (“traits”) which have been obtained by conventional cultivation, by mutagenesis or else by recombinant DNA techniques. These may be cultivars, biotypes or genotypes.

Depending on the plant species or plant cultivars, their location and growth conditions (soils, climate, vegetation period, diet), the treatment in accordance with the invention may also result in superadditive (“synergistic”) effects. Thus, for example, reduced application rates and/or widenings of the activity spectrum and/or an increase in the activity of the substances and compositions that can be used according to the invention including in combination with other agrochemical active compounds, better crop plant growth, increased tolerance of the crop plants to high or low temperatures, increased tolerance of the crop plants to drought or to water or soil salt content, increased flowering performance, easier harvesting, accelerated maturation, higher harvest yields, better quality and/or a higher nutritional value of the harvested products, better storage stability and/or processability of the harvested products which exceed the effects which were actually to be expected are possible.

The preferred transgenic plants or plant cultivars (i.e. those obtained by genetic engineering) which are to be treated according to the invention include all plants which, in the genetic modification, received genetic material which imparted particularly advantageous useful properties (“traits”) to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), corn, soya beans, potatoes, cotton, oilseed rape and also fruit plants (with the fruits apples, pears, citrus fruits and grapes), and particular emphasis is given to corn, soya beans, potatoes, cotton and oilseed rape. Traits that are emphasized are in particular increased defence of the plants against insects by toxins formed in the plants, in particular those formed in the plants by the genetic material from Bacillus thuringiensis (for example by the genes CrylA(a), CrylA(b), CrylA(c), CrylIA, CrylIIA, CrylIIB2, Cry9c, Cry2Ab, Cry3Bb and CrylF and also combinations thereof) (hereinbelow referred to as “Bt plants”). Traits which are also particularly emphasized are the increased resistance of plants to fungi, bacteria and viruses by systemic acquired resistance (SAR), systemin, phytoalexins, elicitors and resistance genes and the correspondingly expressed proteins and toxins. Traits that are furthermore particularly emphasized are the increased tolerance of the plants to certain herbicidally active compounds, for example imidazolinones, sulfonylureas, glyphosate or phosphinothricin (for example the “PAT” gene). The genes which impart the desired traits in question can also be present in combination with one another in the transgenic plants. Examples of “Bt plants” which may be mentioned are corn varieties, cotton varieties, soya bean varieties and potato varieties which are sold under the trade names YIELD GARD®) (for example corn, cotton, soya beans), KnockOut® (for example corn), StarLink® (for example corn), Bollgard® (cotton), Nucotn® (cotton) and NewLeaf® (potato). Examples of herbicide-tolerant plants which may be mentioned are corn varieties, cotton varieties and soya bean varieties which are sold under the trade names Roundup Ready® (tolerance to glyphosates, for example corn, cotton, soya bean), Liberty Link® (tolerance to phosphinothricin, for example oilseed rape), IMI® (tolerance to imidazolinones) and STS® (tolerance to sulfonylureas, for example corn). Herbicide-resistant plants (plants bred in a conventional manner for herbicide tolerance) which may be mentioned include the varieties sold under the name Clearfield® (for example corn). Of course, these statements also apply to plant cultivars having these genetic traits or genetic traits still to be developed, which cultivars will be developed and/or marketed in the future.

The plants listed can be treated according to the invention in a particularly advantageous manner with the compounds of the general formula I or the active compound mixtures according to the invention, the abovementioned synergistic effects occurring with the transgenic plants or plant cultivars in addition to the effective control of weeds. The preferred ranges stated above for the active compounds or mixtures also apply to the treatment of these plants. Particular emphasis is given to the treatment of plants with the compounds or mixtures specifically mentioned in the present text.

The active compounds are also suitable for controlling animal pests, especially arthropods, in particular insects, arachnids and nematodes, which are encountered in agriculture, in forests, in gardens and leisure facilities, in the protection of stored products and of materials, and in the hygiene sector. They may preferably be employed as plant protection agents. They are active against normally sensitive and resistant species and against all or some stages of development. The abovementioned pests include:

From the order of the Isopoda, for example, Oniscus asellus, Armadillidium vulgare and Porcellio scaber.

From the order of the Diplopoda, for example, Blaniulus guttulatus.

From the order of the Chilopoda, for example, Geophilus carpophagus and Scutigera spp.

From the order of the Symphyla, for example, Scutigerella immaculata.

From the order of the Thysanura, for example, Lepisma saccharina.

From the order of the Collembola, for example, Onychiurus armatus.

From the order of the Orthoptera, for example, Acheta domesticus, Gryllotalpa spp., Locusta migratoria migratorioides, Melanoplus spp. and Schistocerca gregaria.

From the order of the Blattaria, for example, Blatta orientalis, Periplaneta americana, Leucophaea maderae, Blattella germanica.

From the order of the Dermaptera, for example, Forficula auricularia.

From the order of the Isoptera, for example, Reticulitermes spp.

From the order of the Phthiraptera, for example, Pediculus humanus corporis, Haematopinus spp., Linognathus spp., Trichodectes spp. and Damalinia spp.

From the order of the Thysanoptera, for example,Hercinothrips femoralis, Thrips tabaci, Thrips palmi and Frankliniella accidentalis.

From the order of the Heteroptera, for example, Eurygaster spp., Dysdercus intermedius, Piesma quadrata, Cimex lectularius, Rhodnius prolixus and Triatoma spp.

From the order of the Homoptera, for example, Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp. and Psylla spp.

From the order of the Lepidoptera, for example, Pectinophora gossypiella, Bupalus piniarius, Cheimatobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp., Oulema oryzae.

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon soistitialis, Costelytra zealandica and Lissorhoptrus oryzophilus.

From the order of the Hymenoptera, for example, Diprion spp., Hoplocampa spp., Lasius spp., Monomorium pharaonis and Vespa spp.

From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp. and Liriomyza spp.

From the order of the Siphonaptera, for example, Xenopsylla cheopis and Ceratophyllus spp.

From the class of the Arachnida, for example, Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp.

The phytoparasitic nematodes include, for example, Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp.

The compounds of the formula (I) according to the invention are particularly suitable for controlling the greenhouse red spider mite (Tetranychus urticae).

If appropriate, the compounds according to the invention can, at certain concentrations or application rates, also be used as microbicides, for example as fungicides, antimycotics and bactericides. If appropriate, they can also be employed as intermediates or precursors for the synthesis of other active compounds.

All plants and plant parts can be treated in accordance with the invention. Plants are to be understood as meaning in the present context all plants and plant populations such as desired and undesired wild plants or crop plants (including naturally occurring crop plants). Crop plants can be plants which can be obtained by conventional plant breeding and optimization methods or by biotechnological and recombinant methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offsets and seeds.

Treatment in accordance with the invention of the plants and plant parts with the active compounds is carried out directly or by allowing the compounds to act on the surroundings, environment or storage space by the customary treatment methods, for example by immersion, spraying, evaporation, fogging, scattering, painting on, injecting and, in the case of propagation material, in particular in the case of seeds, also by applying one or more coats.

The active compounds can be converted into the customary formulations, such as solutions, emulsions, wettable powders, suspensions, powders, dusts, pastes, soluble powders, granules, suspension-emulsion concentrates, natural and synthetic materials impregnated with active compound and microencapsulations in polymeric substances.

These formulations are produced in a known manner, for example by mixing the active compounds with extenders, that is liquid solvents, and/or solid carriers, optionally with the use of surfactants, that is emulsifiers and/or dispersants, and/or foam formers.

If the extender used is water, it is also possible to employ for example organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulfoxide, and also water.

Suitable solid carriers are:

for example ammonium salts and ground natural minerals such as kaolins, clays, talc, chalk, quartz, attapulgite, montmorillonite or diatomaceous earth, and ground synthetic minerals, such as highly disperse silica, alumina and silicates; suitable solid carriers for granules are: for example crushed and fractionated natural rocks such as calcite, marble, pumice, sepiolite and dolomite, and also synthetic granules of inorganic and organic meals, and granules of organic material such as sawdust, coconut shells, corn cobs and tobacco stalks; suitable emulsifiers and/or foam formers are: for example nonionogenic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates and also protein hydrolysates; suitable dispersants are: for example lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, as well as natural phospholipids such as cephalins and lecithins, and synthetic phospholipids, can be used in the formulations. Other possible additives are mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95% by weight of active compound, preferably between 0.5 and 90%.

The active compound according to the invention can be present in its commercially available formulations and in the use forms prepared from these formulations as a mixture with other active compounds, such as insecticides, attractants, sterilants, bactericides, acaricides, nematicides, fungicides, growth-regulating compounds or herbicides. The insecticides include, for example, phosphoric esters, carbamates, carboxylic esters, chlorinated hydrocarbons, phenylureas, compounds produced by microorganisms, inter alia.

Particularly suitable mixing components are, for example, the following compounds:

Fungicides:

2-phenylphenol; 8-hydroxyquinoline sulfate; acibenzolar-S-methyl; aldimorph; amidoflumet; ampropylfos; ampropylfos-potassium; andoprim; anilazine; azaconazole; azoxystrobin; benalaxyl; benodanil; benomyl; benthiavalicarb-isopropyl; benzamacril; benzamacril-isobutyl; bilanafos; binapacryl; biphenyl; bitertanol; blasticidin-S; bromuconazole; bupirimate; buthiobate; butylamine; calcium polysulfide; capsimycin; captafol; captan; carbendazim; carboxin; carpropamid; carvone; chinomethionat; chlobenthiazone; chlorfenazole; chloroneb; chlorothalonil; chlozolinate; clozylacon; cyazofamid; cyflufenamid; cymoxanil; cyproconazole; cyprodinil; cyprofuram; Dagger G; debacarb; dichlofluanid; dichlone; dichlorophen; diclocymet; diclomezine; dicloran; diethofencarb; difenoconazole; diflumetorim; dimethirimol; dimethomorph; dimoxystrobin; diniconazole; diniconazole-M; dinocap; diphenylamine; dipyrithione; ditalimfos; dithianon; dodine; drazoxolon; edifenphos; epoxiconazole; ethaboxam; ethirimol; etridiazole; famoxadone; fenamidone; fenapanil; fenarimol; fenbuconazole; fenfuram; fenhexamid; fenitropan; fenoxanil; fenpiclonil; fenpropidin; fenpropimorph; ferbam; fluazinam; flubenzimine; fludioxonil; flumetover; flumorph; fluoromide; fluoxastrobin; fluquinconazole; flurprimidol; flusilazole; flusulfamide; flutolanil; flutriafol; folpet; fosetyl-Al; fosetyl-sodium; fuberidazole; furalaxyl; furametpyr; furcarbanil; furmecyclox; guazatine; hexachlorobenzene; hexaconazole; hymexazole; imazalil; imibenconazole; iminoctadine triacetate; iminoctadine tris(albesilate); iodocarb; ipconazole; iprobenfos; iprodione; iprovalicarb; irumamycin; isoprothiolane; isovaledione; kasugamycin; kresoxim-methyl; mancozeb; maneb; meferimzone; mepanipyrim; mepronil; metalaxyl; metalaxyl-M; metconazole; methasulfocarb; methfuroxam; metiram; metominostrobin; metsulfovax; mildiomycin; myclobutanil; myclozolin; natamycin; nicobifen; nitrothal-isopropyl; noviflumuron; nuarimol; ofurace; orysastrobin; oxadixyl; oxolinic acid; oxpoconazole; oxycarboxin; oxyfenthiin; paclobutrazole; pefurazoate; penconazole; pencycuron; phosdiphen; phthalide; picoxystrobin; piperalin; polyoxins; polyoxorim; probenazole; prochloraz; procymidone; propamocarb; propanosine-sodium; propiconazole; propineb; proquinazid; prothioconazole; pyraclostrobin; pyrazophos; pyrifenox; pyrimethanil; pyroquilon; pyroxyfur; pyrrolenitrine; quinconazole; quinoxyfen; quintozene; simeconazole; spiroxamine; sulfur; tebuconazole; tecloftalam; tecnazene; tetcyclacis; tetraconazole; thiabendazole; thicyofen; thifluzamide; thiophanate-methyl; thiram; tioxymid; tolclofos-methyl; tolylfluanid; triadimefon; triadimenol; triazbutil; triazoxide; tricyclamide; tricyclazole; tridemorph; trifloxystrobin; triflumizole; triforine; triticonazole; uniconazole; validamycin A; vinclozolin; zineb; ziram; zoxamide; (2S)-N-[2-[4-[[3-(4-chlorophenyl)-2-propynyl]oxy]-3-methoxyphenyl]ethyl]-3-methyl-2-[(methylsulfonyl)amino]butanamide; 1-(1-naphthalenyl)-1H-pyrrole-2,5-dione; 2,3,5,6-tetrachloro-4-(methylsulfonyl)pyridine; 2-amino4-methyl-N-phenyl-5-thiazolecarboxamide; 2-chloro-N-(2,3-dihydro-1,1,3-trimethyl-1H-inden-4-yl )-3-pyridinecarboxamide; 3,4,5-trichloro-2,6-pyridinedicarbonitrile; actinovate; cis-1-(4-chlorophenyl)-2-(1H-1,2,4-triazol-1-yl)cycloheptanol; methyl 1-(2,3-dihydro-2,2-dimethyl-1H-inden-1-yl)-1H-imidazole-5-carboxylate; monopotassium carbonate; N-(6-methoxy-3-pyridinyl)-cyclopropanecarboxamide; N-butyl-8-(1,1-dimethylethyl)-1-oxaspiro[4.5]decane-3-amine; sodium tetrathiocarbonate;

and copper salts and preparations, such as Bordeaux mixture; copper hydroxide; copper naphthenate; copper oxychloride; copper sulfate; cufraneb; copper oxide; mancopper; oxine-copper.

Bactericides:

bronopol, dichlorophen, nitrapyrin, nickel dimethyidithiocarbamate, kasugamycin, octhilinone, furancarboxylic acid, oxytetracyclin, probenazole, streptomycin, tecloftalam, copper sulfate and other copper preparations.

Insecticides/Acaricides/Nematicides:

abamectin, ABG-9008, acephate, acequinocyl, acetamiprid, acetoprole, acrinathrin, AKD-1022, AKD-3059, AKD-3088, alanycarb, aldicarb, aldoxycarb, allethrin, allethrin 1R-isomers, alpha-cypermethrin (alphamethrin), amidoflumet, aminocarb, amitraz, avermectin, AZ-60541, azadirachtin, azamethiphos, azinphos-methyl, azinphos-ethyl, azocyclotin,

Bacillus popilliae, Bacillus sphaericus, Bacillus subtilis, Bacillus thuringiensis, Bacillus thuringiensis strain EG-2348, Bacillus thuringiensis strain GC-91, Bacillus thuringiensis strain NCTC-11821, baculoviruses, Beauveria bassiana, Beauveria tenella, benclothiaz, bendiocarb, benfuracarb, bensultap, benzoximate, beta-cyfluthrin, beta-cypermethrin, bifenazate, bifenthrin, binapacryl, bioallethrin, bioallethrin-S-cyclopentyl-isomer, bioethanomethrin, biopermethrin, bioresmethrin, bistrifluron, BPMC, brofenprox, bromophos-ethyl, bromopropylate, bromfenvinfos (-methyl), BTG-504, BTG-505, bufencarb, buprofezin, butathiofos, butocarboxim, butoxycarboxim, butylpyridaben,

cadusafos, camphechlor, carbaryl, carbofuran, carbophenothion, carbosulfan, cartap, CGA-50439, chinomethionat, chlordane, chlordimeform, chloethocarb, chlorethoxyfos, chlorfenapyr, chlorfenvinphos, chlorfluazuron, chlormephos, chloro-benzilate, chloropicrin, chlorproxyfen, chlorpyrifos-methyl, chlorpyrifos (-ethyl), chlovaporthrin, chromafenozide, cis-cypermethrin, cis-resmethrin, cis-permethrin, clocythrin, cloethocarb, clofentezine, clothianidin, clothiazoben, codlemone, coumaphos, cyanofenphos, cyanophos, cycloprene, cycloprothrin, Cydia pomonella, cyfluthrin, cyhalothrin, cyhexatin, cypermethrin, cyphenothrin (1R-trans-isomer), cyromazine,

DDT, deltamethrin, demeton-S-methyl, demeton-S-methylsulfone, diafenthiuron, dialifos, diazinon, dichlofenthion, dichlorvos, dicofol, dicrotophos, dicyclanil, diflu-benzuron, dimefluthrin, dimethoate, dimethylvinphos, dinobuton, dinocap, dinotefuran, diofenolan, disulfoton, docusat-sodium, dofenapyn, DOWCO-439,

eflusilanate, emamectin, emamectin-benzoate, empenthrin (1R-isomer), endosulfan, Entomopthora spp., EPN, esfenvalerate, ethiofencarb, ethiprole, ethion, ethoprophos, etofenprox, etoxazole, etrimfos,

famphur, fenamiphos, fenazaquin, fenbutatin oxide, fenfluthrin, fenitrothion, fenobucarb, fenothiocarb, fenoxacrim, fenoxycarb, fenpropathrin, fenpyrad, fenpyrithrin, fenpyroximate, fensulfothion, fenthion, fentrifanil, fenvalerate, fipronil, flonicamid, fluacrypyrim, fluazuron, flubenzimine, flubrocythrinate, flucycloxuron, flucythrinate, flufenerim, flufenoxuron, flufenprox, flumethrin, flupyrazofos, flutenzin (flufenzine), fluvalinate, fonofos, formetanate, formothion, fosmethilan, fosthiazate, fubfenprox (fluproxyfen), furathiocarb,

gamma-HCH, gossyplure, grandlure, granulosis viruses,

halfenprox, halofenozide, HCH, HCN-801, heptenophos, hexaflumuron, hexythiazox, hydramethylnone, hydroprene,

IKA-2002, imidacloprid, imiprothrin, indoxacarb, iodofenphos, iprobenfos, isazofos, isofenphos, isoprocarb, isoxathion, ivermectin,

japonilure,

kadethrin, nuclear polyhedrosis viruses, kinoprene,

lambda-cyhalothrin, lindane, lufenuron,

malathion, mecarbam, mesulfenfos, metaldehyde, metam-sodium, methacrifos, methamidophos, Metharhizium anisopliae, Metharhizium flavoviride, methidathion, methiocarb, methomyl, methoprene, methoxychlor, methoxyfenozide, metofluthrin, metolcarb, metoxadiazone, mevinphos, milbemectin, milbemycin, MKI-245, MON-45700, monocrotophos, moxidectin, MTI-800,

naled, NC-104, NC-170, NC-184, NC-194, NC-196, niclosamide, nicotine, niten-pyram, nithiazine, NNI-0001, NNI-0101, NNI-0250, NNI-9768, novaluron, novi-flumuron,

OK-5101, OK-5201, OK-9601, OK-9602, OK-9701, OK-9802, omethoate, oxamyl, oxydemeton-methyl,

Paecilomyces fumosoroseus, parathion-methyl, parathion (-ethyl), permethrin (cis-, trans-), petroleum, PH-6045, phenothrin (1R-trans isomer), phenthoate, phorate, phosalone, phosmet, phosphamidon, phosphocarb, phoxim, piperonyl butoxide, pirimicarb, pirimiphos-methyl, pirimiphos-ethyl, potassium oleate, prallethrin, profenofos, profluthrin, promecarb, propaphos, propargite, propetamphos, propoxur, prothiofos, prothoate, protrifenbute, pymetrozine, pyraclofos, pyresmethrin, pyrethrum, pyridaben, pyridalyl, pyridaphenthion, pyridathion, pyrimidifen, pyriproxyfen,

quinalphos,

resmethrin, RH-5849, ribavirin, RU-12457, RU-15525,

S-421, S-1833, salithion, sebufos, SI-0009, silafluofen, spinosad, spirodiclofen, spiromesifen, sulfluramid, sulfotep, sulprofos, SZI-121,

tau-fluvalinate, tebufenozide, tebufenpyrad, tebupirimfos, teflubenzuron, tefluthrin, temephos, temivinphos, terbam, terbufos, tetrachlorvinphos, tetradifon, tetramethrin, tetramethrin (1R-isomer), tetrasul, theta-cypermethrin, thiacloprid, thiamethoxam, thiapronil, thiatriphos, thiocyclam hydrogenoxalate, thiodicarb, thiofanox, thiometon, thiosultap-sodium, thuringiensin, tolfenpyrad, tralocythrin, tralomethrin, transfluthrin, triarathene, triazamate, triazophos, triazuron, trichlophenidine, trichlorfon, triflumuron, trimethacarb,

vamidothion, vaniliprole, verbutin, Verticillium lecanii,

WL-108477, WL-40027,

YI-5201, YI-5301, YI-5302,

XMC, xylylcarb,

ZA-3274, zeta-cypermethrin, zolaprofos, ZXI-8901,

the compound 3-methylphenyl propylcarbamate (tsumacide Z),

the compound 3-(5-chloro-3-pyridinyl)-8-(2,2,2-trifluoroethyl)-8-azabicyclo[3.2.1]-octane-3-carbonitrile (CAS-Reg. No.185982-80-3) and the corresponding 3-endo-isomer (CAS-Reg. No. 185984-60-5) (cf. WO-96/37494, WO-98/25923),

and preparations which comprise insecticidally active plant extracts, nematodes, fungi or viruses.

A mixture with other known active compounds, such as herbicides, or with fertilizers and growth regulators, safeners or semiochemicals is also possible.

When used as insecticides, the active compounds according to the invention can furthermore be present in their commercially available formulations and in the use forms, prepared from these formulations, as a mixture with synergistic agents. Synergistic agents are compounds which increase the action of the active compounds, without it being necessary for the synergistic agent added to be active itself.

When used as insecticides, the active compounds according to the invention can furthermore be present in their commercially available formulations and in the use forms, prepared from these formulations, as a mixture with inhibitors which reduce the degradation of the active compound after use in the vicinity of the plant, on the surface of plant parts or in plant tissues.

The active compound content of the use forms prepared from the commercially available formulations can vary within wide limits. The active compound concentration of the use forms can be from 0.0000001 to 95% by weight of active compound, preferably between 0.0001 and 1% by weight.

The compounds are employed in a customary manner appropriate for the use forms.

When used against hygiene pests and pests of stored products, the active compound has an excellent residual action on wood and clay as well as a good stability to alkali on limed substrates.

As already mentioned above, it is possible to treat all plants and their parts in accordance with the invention. In a preferred embodiment, wild plant species and plant cultivars, or those obtained by conventional biological breeding methods, such as crossing or protoplast fusion, and parts thereof, are treated. In a further preferred embodiment, the transgenic plants and plant cultivars described in more detail above and obtained by genetic engineering, if appropriate in combination with conventional methods (Genetically Modified Organisms), and parts thereof are treated. The term “parts” or “parts of plants” or “plant parts” has likewise already been explained above.

The active compounds according to the invention act not only against plant, hygiene and stored product pests, but also in the veterinary medicine sector against animal parasites (ectoparasites), such as hard ticks, soft ticks, mange mites, leaf mites, flies (biting and licking), parasitic fly larvae, lice, hair lice, feather lice and fleas. These parasites include:

From the order of the Anoplurida, for example, Haematopinus spp., Linognathus spp., Pediculus spp., Phtirus spp. and Solenopotes spp.

From the order of the Mallophagida and the suborders Amblycerina and Ischnocerina, for example, Trimenopon spp., Menopon spp., Trinoton spp., Bovicola spp., Werneckiella spp., Lepikentron spp., Damalina spp., Trichodectes spp. and Felicola spp.

From the order of the Diptera and the suborders Nematocerina and Brachycerina, for example, Aedes spp., Anopheles spp., Culex spp., Simulium spp., Eusimulium spp., Phlebotomus spp., Lutzomyia spp., Culicoides spp., Chrysops spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp. and Melophagus spp.

From the order of the Siphonapterida, for example, Pulex spp., Ctenocephalides spp., Xenopsylla spp. and Ceratophyllus spp.

From the order of the Heteropterida, for example, Cimex spp., Triatoma spp., Rhodnius spp. and Panstrongylus spp.

From the order of the Blattarida, for example, Blatta orientalis, Periplaneta americana, Blattela germanica and Supella spp.

From the subclass of the Acaria (Acarina) and the orders of the Meta- and Mesostigmata, for example, Argas spp., Ornithodorus spp., Otobius spp., Ixodes spp., Amblyomma spp., Boophilus spp., Dermacentor spp., Haemophysalis spp., Hyalomma spp., Rhipicephalus spp., Dermanyssus spp., Raillietia spp., Pneumonyssus spp., Sternostoma spp. and Varroa spp.

From the order of the Actinedida (Prostigmata) and Acaridida (Astigmata), for example, Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp. and Laminosioptes spp.

The active compounds of the formula (I) according to the invention are also suitable for controlling arthropods which infest agricultural productive livestock, such as, for example, cattle, sheep, goats, horses, pigs, donkeys, camels, buffalo, rabbits, chickens, turkeys, ducks, geese and bees, other pets, such as, for example, dogs, cats, caged birds and aquarium fish, and also so-called test animals, such as, for example, hamsters, guinea pigs, rats and mice. By controlling these arthropods, cases of death and reduction in productivity (for meat, milk, wool, hides, eggs, honey etc.) should be diminished, so that more economic and easier animal husbandry is possible by use of the active compounds according to the invention.

The active compounds according to the invention are used in the veterinary sector in a known manner by enteral administration in the form of, for example, tablets, capsules, potions, drenches, granules, pastes, boluses, the feed-through process and suppositories, by parenteral administration, such as, for example, by injection (intramuscular, subcutaneous, intravenous, intraperitoneal and the like), implants, by nasal administration, by dermal use in the form, for example, of dipping or bathing, spraying, pouring on and spotting on, washing and powdering, and also with the aid of molded articles containing the active compound, such as collars, ear marks, tail marks, limb bands, halters, marking devices and the like.

When used for cattle, poultry, pets and the like, the active compounds of the formula (I) can be used as formulations (for example powders, emulsions, free-flowing compositions), which comprise the active compounds in an amount of 1 to 80% by weight, directly or after 100 to 10 000-fold dilution, or they can be used as a chemical bath.

It has furthermore been found that the compounds according to the invention have a strong insecticidal action against insects which destroy industrial materials.

The following insects may be mentioned as examples and as preferred—but without limitation:

Beetles, such as Hylotrupes bajulus, Chlorophorus pilosis, Anobium punctatum, Xestobium rufovillosum, Ptilinus pecticornis, Dendrobium pertinex, Ernobius mollis, Priobium carpini, Lyctus brunneus, Lyctus africanus, Lyctus planicollis, Lyctus linearis, Lyctus pubescens, Trogoxylon aequale, Minthes rugicollis, Xyleborus spec. Tryptodendron spec. Apate monachus, Bostrychus capucins, Heterobostrychus brunneus, Sinoxylon spec. Dinoderus minutus;

Hymenopterons, such as Sirex juvencus, Urocerus gigas, Urocerus gigas taignus, Urocerus augur;

Termites, such as Kalotermes flavicollis, Cryptotermes brevis, Heterotermes indicola, Reticulitermes flavipes, Reticulitermes santonensis, Reticulitermes lucifugus, Mastotermes darwiniensis, Zootermopsis nevadensis, Coptotermes formosanus;

Bristletails, such as Lepisma saccharina.

Industrial materials in the present connection are to be understood as meaning non-living materials, such as, preferably, plastics, adhesives, sizes, papers and cards, leather, wood and processed wood products and coating compositions.

Wood and processed wood products are materials to be protected, especially preferably, from insect infestation.

Wood and processed wood products which can be protected by the agent of the invention or mixtures comprising it are to be understood as meaning, for example:

building timber, wooden beams, railway sleepers, bridge components, boat jetties, wooden vehicles, boxes, pallets, containers, telegraph poles, wood panelling, wooden windows and doors, plywood, chipboard, joinery or wooden products which are used quite generally in house-building or in building joinery.

The active compounds can be used as such, in the form of concentrates or generally customary formulations, such as powders, granules, solutions, suspensions, emulsions or pastes.

The formulations mentioned can be prepared in a manner known per se, for example by mixing the active compounds with at least one solvent or diluent, emulsifier, dispersing agent and/or binder or fixing agent, a water repellent, if appropriate siccatives and UV stabilizers and if appropriate dyestuffs and pigments, and also other processing auxiliaries.

The insecticidal compositions or concentrates used for the preservation of wood and wood-derived timber products comprise the active compound according to the invention in a concentration of 0.0001 to 95% by weight, in particular 0.001 to 60% by weight.

The amount of the compositions or concentrates employed depends on the nature and occurrence of the insects and on the medium. The optimum amount employed can be determined for the use in each case by a series of tests. In general, however, it is sufficient to employ 0.0001 to 20% by weight, preferably 0.001 to 10% by weight, of the active compound, based on the material to be preserved.

Solvents and/or diluents which are used are an organic chemical solvent or solvent mixture and/or an oily or oil-like organic chemical solvent or solvent mixture of low volatility and/or a polar organic chemical solvent or solvent mixture and/or water, and if appropriate an emulsifier and/or wetting agent.

Organic chemical solvents which are preferably used are oily or oil-like solvents having an evaporation number above 35 and a flashpoint above 30° C., preferably above 45° C. Substances which are used as such oily or oil-like water-insoluble solvents of low volatility are appropriate mineral oils or aromatic fractions thereof, or solvent mixtures containing mineral oils, preferably white spirit, petroleum and/or alkylbenzene.

Mineral oils having a boiling range from 170 to 220° C., white spirit having a boiling range from 170 to 220° C., spindle oil having a boiling range from 250 to 350° C., petroleum and aromatics having a boiling range from 160 to 280° C., terpentine oil and the like are advantageously employed.

In a preferred embodiment, liquid aliphatic hydrocarbons having a boiling range from 180 to 210° C. or high-boiling mixtures of aromatic and aliphatic hydrocarbons having a boiling range from 180 to 220° C. and/or spindle oil and/or monochloronaphthalene, preferably x-monochloronaphthalene, are used.

The organic oily or oil-like solvents of low volatility which have an evaporation number above 35 and a flashpoint above 30° C., preferably above 45° C., can be replaced in part by organic chemical solvents of high or medium volatility, provided that the solvent mixture likewise has an evaporation number above 35 and a flashpoint above 30° C., preferably above 45° C., and that the insecticide/fungicide mixture is soluble or emulsifiable in this solvent mixture.

According to a preferred embodiment, some of the organic chemical solvent or solvent mixture or an aliphatic polar organic chemical solvent or solvent mixture is replaced. Aliphatic organic chemical solvents containing hydroxyl and/or ester and/or ether groups, such as, for example, glycol ethers, esters or the like, are preferably used.

Organic chemical binders which are used in the context of the present invention are the synthetic resins and/or binding drying oils which are known per se, are water-dilutable and/or are soluble or dispersible or emulsifiable in the organic chemical solvents employed, in particular binders consisting of or comprising an acrylate resin, a vinyl resin, for example polyvinyl acetate, polyester resin, polycondensation or polyaddition resin, polyurethane resin, alkyd resin or modified alkyd resin, phenolic resin, hydrocarbon resin, such as indene-cumarone resin, silicone resin, drying vegetable oils and/or drying oils and/or physically drying binders based on a natural and/or synthetic resin.

The synthetic resin used as the binder can be employed in the form of an emulsion, dispersion or solution. Bitumen or bituminous substances can also be used as binders in an amount of up to 10% by weight. Dyestuffs, pigments, water-repelling agents, odor correctants and inhibitors or anticorrosive agents and the like which are known per se can additionally be employed.

It is preferred according to the invention for the composition or concentrate to comprise, as the organic chemical binder, at least one alkyd resin or modified alkyd resin and/or one drying vegetable oil. Alkyd resins having an oil content of more than 45% by weight, preferably 50 to 68% by weight, are preferably used according to the invention.

All or some of the binder mentioned can be replaced by a fixing agent (mixture) or a plasticizer (mixture). These additives are intended to prevent evaporation of the active compounds and crystallization or precipitation. They preferably replace 0.01 to 30% of the binder (based on 100% of the binder employed).

The plasticizers originate from the chemical classes of phthalic acid esters, such as dibutyl, dioctyl or benzyl butyl phthalate, phosphoric acid esters, such as tributyl phosphate, adipic acid esters, such as di-(2-ethylhexyl) adipate, stearates, such as butyl stearate or amyl stearate, oleates, such as butyl oleate, glycerol ethers or higher molecular weight glycol ethers, glycerol esters and p-toluenesulfonic acid esters.

Fixing agents are based chemically on polyvinyl alkyl ethers, such as, for example, polyvinyl methyl ether or ketones, such as benzophenone or ethylenebenzophenone.

Possible solvents or diluents are, in particular, also water, if appropriate as a mixture with one or more of the abovementioned organic chemical solvents or diluents, emulsifiers and dispersing agents.

Particularly effective preservation of wood is achieved by impregnation processes on a large industrial scale, for example vacuum, double vacuum or pressure processes.

The ready-to-use compositions can also comprise other insecticides, if appropriate, and also one or more fungicides, if appropriate.

Possible additional mixing partners are, preferably, the insecticides and fungicides mentioned in WO 94/29 268. The compounds mentioned in this document are an explicit constituent of the present application.

Especially preferred mixing partners which may be mentioned are insecticides, such as chloropyriphos, phoxim, silafluofin, alphamethrin, cyfluthrin, cypermethrin, deltamethrin, permethrin, imidacloprid, NI-25, flufenoxuron, hexaflumuron, transfluthrin, thiacloprid, methoxyfenozide, triflumuron, clothianidin, spinosad, tefluthrin,

and also fungicides, such as epoxyconazole, hexaconazole, azaconazole, propiconazole, tebuconazole, cyproconazole, metconazole, imazalil, dichlorofluanid, tolylfluanid, 3-iodo-2-propinyl-butyl carbamate, N-octyl-isothiazolin-3-one and 4,5-dichloro-N-octylisothiazolin-3-one.

The compounds according to the invention can at the same time be employed for protecting objects which come into contact with saltwater or brackish water, in particular hulls, screens, nets, buildings, moorings and signalling systems, against fouling.

Fouling by sessile Oligochaeta, such as Serpulidae, and by shells and species from the Ledamorpha group (goose barnacles), such as various Lepas and Scalpellum species, or by species from the Balanomorpha group (acorn barnacles), such as Balanus or Pollicipes species, increases the frictional drag of ships and, as a consequence, leads to a marked increase in operation costs owing to higher energy consumption and additionally frequent residence in the dry dock.

Apart from fouling by algae, for example Ectocarpus sp. and Ceramium sp., in particular fouling by sessile Entomostraka groups, which come under the generic term Cirripedia (cirriped crustaceans), is of particular importance.

Surprisingly, it has now been found that the compounds according to the invention, alone or in combination with other active compounds, have an outstanding antifouling action.

Using compounds according to the invention, alone or in combination with other active compounds, allows the use of heavy metals such as, for example, in bis(trialkyltin) sulfides, tri-n-butyltin laurate, tri-n-butyltin chloride, copper(I) oxide, triethyltin chloride, tri-n-butyl(2-phenyl4-chlorophenoxy)tin, tributyltin oxide, molybdenum disulfide, antimony oxide, polymeric butyl titanate, phenyl-(bispyridine)bismuth chloride, tri-n-butyltin fluoride, manganese ethylenebisthio-carbamate, zinc dimethyldithiocarbamate, zinc ethylenebisthiocarbamate, zinc salts and copper salts of 2-pyridinethiol 1-oxide, bisdimethyldithiocarbamoylzinc ethylene-bisthiocarbamate, zinc oxide, copper(I) ethylene-bisdithiocarbamate, copper thiocyanate, copper naphthenate and tributyltin halides to be dispensed with, or the concentration of these compounds to be substantially reduced.

If appropriate, the ready-to-use antifouling paints can additionally comprise other active compounds, preferably algicides, fungicides, herbicides, molluscicides, or other antifouling active compounds.

Preferably suitable components in combinations with the antifouling compositions according to the invention are:

algicides such as 2-tert-butylamino-4-cyclopropylamino-6-methylthio-1,3,5-triazine, dichlorophen, diuron, endothal, fentin acetate, isoproturon, methabenzthiazuron, oxyfluorfen, quinoclamine and terbutryn;

fungicides such as benzo[b]thiophenecarboxylic acid cyclohexylamide S,S-dioxide, dichlofluanid, fluorfolpet, 3-iodo-2-propinyl butylcarbamate, tolylfluanid and azoles such as azaconazole, cyproconazole, epoxyconazole, hexaconazole, metconazole, propiconazole and tebuconazole;

molluscicides such as fentin acetate, metaldehyde, methiocarb, niclosamid, thiodicarb and trimethacarb, fechelate;

or conventional antifouling active compounds such as 4,5-dichloro-2-octyl-4-iso-thiazolin-3-one, diiodomethylparatryl sulfone, 2-(N,N-dimethylthiocarbamoylthio)-5-nitrothiazyl, potassium, copper, sodium and zinc salts of 2-pyridinethiol 1-oxide, pyridine-triphenylborane, tetrabutyldistannoxane, 2,3,5,6-tetrachloro-4-(methylsulfonyl)-pyridine, 2,4,5,6-tetrachloroisophthalonitrile, tetramethylthiuram disulfide and 2,4,6-trichlorophenylmaleinimide.

The antifouling compositions used comprise the active compound according to the invention of the compounds according to the invention in a concentration of 0.001 to 50% by weight, in particular 0.01 to 20% by weight.

Moreover, the antifouling compositions according to the invention comprise the customary components such as, for example, those described in Ungerer, Chem. Ind. 1985, 37, 730-732 and Williams, Antifouling Marine Coatings, Noyes, Park Ridge, 1973.

Besides the algicidal, fungicidal, molluscicidal active compounds and insecticidal active compounds according to the invention, antifouling paints comprise, in particular, binders.

Examples of recognized binders are polyvinyl chloride in a solvent system, chlorinated rubber in a solvent system, acrylic resins in a solvent system, in particular in an aqueous system, vinyl chloride/vinyl acetate copolymer systems in the form of aqueous dispersions or in the form of organic solvent systems, butadiene/styrene/acrylonitrile rubbers, drying oils such as linseed oil, resin esters or modified hardened resins in combination with tar or bitumens, asphalt and epoxy compounds, small amounts of chlorine rubber, chlorinated polypropylene and vinyl resins.

If appropriate, paints also comprise inorganic pigments, organic pigments or colorants which are preferably insoluble in salt water. Paints may furthermore comprise materials such as colophonium to allow controlled release of the active compounds. Furthermore, the paints may comprise plasticizers, modifiers which affect the rheological properties and other conventional constituents. The compounds according to the invention or the abovementioned mixtures may also be incorporated into self-polishing antifouling systems.

The active compounds are also suitable for controlling animal pests, in particular insects, arachnids and mites, which are found in enclosed spaces such as, for example, dwellings, factory halls, offices, vehicle cabins and the like. They can be employed alone or in combination with other active compounds and auxiliaries in domestic insecticide products for controlling these pests. They are active against sensitive and resistant species and against all developmental stages. These pests include:

From the order of the Scorpionidea, for example, Buthus occitanus.

From the order of the Acarina, for example, Argas persicus, Argas reflexus, Bryobia ssp., Dermanyssus gallinae, Glyciphagus domesticus, Ornithodorus moubat, Rhipicephalus sanguineus, Trombicula alfreddugesi, Neutrombicula autumnalis, Dermatophagoides pteronissimus, Dermatophagoides forinae.

From the order of the Araneae, for example, Aviculariidae, Araneidae.

From the order of the Opiliones, for example, Pseudoscorpiones chelifer, Pseudoscorpiones cheiridium, Opiliones phalangium.

From the order of the Isopoda, for example, Oniscus asellus, Porcellio scaber.

From the order of the Diplopoda, for example, Blaniulus guttulatus, Polydesmus spp.

From the order of the Chilopoda, for example, Geophilus spp.

From the order of the Zygentoma, for example, Ctenolepisma spp., Lepisma saccharina, Lepismodes inquilinus.

From the order of the Blattaria, for example, Blatta orientalies, Blattella germanica, Blattella asahinai, Leucophaea maderae, Panchlora spp., Parcoblatta spp., Periplaneta australasiae, Periplaneta americana, Periplaneta brunnea, Periplaneta fuliginosa, Supella longipalpa.

From the order of the Saltatoria, for example, Acheta domesticus.

From the order of the Dermaptera, for example, Forficula auricularia.

From the order of the Isoptera, for example, Kalotermes spp., Reticulitermes spp.

From the order of the Psocoptera, for example, Lepinatus spp., Liposcelis spp.

From the order of the Coleoptera, for example,Anthrenus spp., Attagenus spp., Dermestes spp., Latheticus oryzae, Necrobia spp., Ptinus spp., Rhizopertha dominica, Sitophilus granarius, Sitophilus oryzae, Sitophilus zeamais, Stegobium paniceum.

From the order of the Diptera, for example, Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga carnaria, Simulium spp., Stomoxys calcitrans, Tipula paludosa.

From the order of the Lepidoptera, for example, Achroia grisella, Galleria mellonella, Plodia interpunctella, Tinea cloacella, Tinea pellionella, Tineola bisselliella.

From the order of the Siphonaptera, for example, Ctenocephalides canis, Ctenocephalides felis, Pulex irritans, Tunga penetrans, Xenopsylla cheopis.

From the order of the Hymenoptera, for example, Camponotus herculeanus, Lasius fuliginosus, Lasius niger, Lasius umbratus, Monomorium pharaonis, Paravespula spp., Tetramorium caespitum.

From the order of the Anoplura, for example, Pediculus humanus capitis, Pediculus humanus corporis, Phthirus pubis.

From the order of the Heteroptera, for example, Cimex hemipterus, Cimex lectularius, Rhodinus prolixus, Triatoma infestans.

In the field of household insecticides, they are used alone or in combination with other suitable active compounds, such as phosphoric acid esters, carbamates, pyrethroids, neonicotinoids, growth regulators or active compounds from other known classes of insecticide.

They are used in aerosols, pressure-free spray products, for example pump and atomizer sprays, automatic fogging systems, foggers, foams, gels, evaporator products with evaporator tablets made of cellulose or polymer, liquid evaporators, gel and membrane evaporators, propeller-driven evaporators, energy-free or passive evaporation systems, moth papers, moth bags and moth gels, as granules or dusts, in baits for spreading or in bait stations.

### PREPARATION EXAMPLES

### Example 1

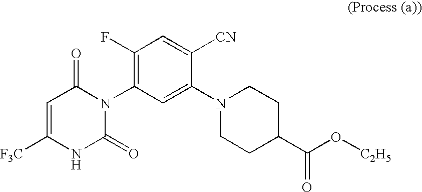

A mixture of 9.00 g (28.4 mmol) of 3-(4-cyano-2,5-difluorophenyl)-6-trifluoromethyl-1H-pyrimidine-2,4-dione, 7.8 g (56 mmol) of potassium carbonate and 150 ml of dimethyl sulfoxide is stirred at room temperature (about 20° C.) for 10 minutes. 4.46 g (28.4 mmol) of ethyl piperidine-4-carboxylate are then added to the mixture, and the reaction mixture is stirred at 180° C. for 15 hours. After cooling to room temperature, the mixture is poured into about double the volume of aqueous 2N hydrochloric acid, and the resulting crystalline product is isolated by filtration with suction.

This gives 6.1 g (40% of theory) of 3-[4-cyano-5-(4-ethoxycarbonylpiperidin-1-yl)-2-fluorophenyl]-6-trifluoromethyl-1H-pyrimidine-2,4-dione of melting point 124.5° C.

### Example 2

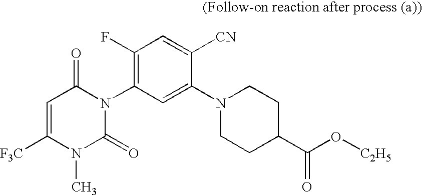

A mixture of 2.5 g (5.5 mmol) of 3-[4-cyano-5-(4-ethoxycarbonylpiperidin-1-yl)-2-fluorophenyl]-6-trifluoromethyl-1H-pyrimidine-2,4-dione (cf. Example 1), 0.9 g (6.6 mmol) of potassium carbonate and 75 ml of acetonitrile is stirred at room temperature (about 20° C.) for 10 minutes. A solution of 0.83 g (6.6 mmol) of dimethyl sulfate in 5 ml of acetonitrile is then added dropwise with stirring, and the reaction mixture is stirred at 45° C. for 2 hours. The mixture is then poured into about double the volume of water and extracted with methylene chloride. The organic extract is dried with sodium sulfate and filtered. The filtrate is concentrated under reduced pressure, the residue is digested with n-hexane and the resulting crystalline product is isolated by filtration with suction.

This gives 1.95 g (67% of theory) of 3-[4-cyano-5-(4-ethoxycarbonylpiperidin-1-yl)-2-fluorophenyl]-1-methyl-6-trifluoromethyl-1H-pyrimidine-2,4-dione.

log P(pH=2.3): 3.23

### Example 3

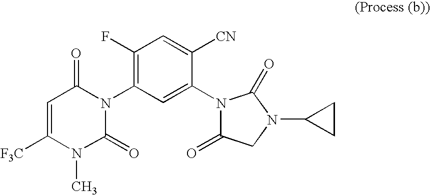

A mixture of 0.45 g (1.27 mmol) of 3-(4-cyano-2-fluoro-5-isocyanatophenyl)-1-methyl-6-trifluoromethyl-1H-pyrimidine-2,4-dione, 0.18 g (1.27 mmol) of ethyl cyclopropylaminoacetate, 1 mg of 1,4-diazabicyclo[2.2.2]octane and 10 ml of aceto-nitrile is stirred at 60° C. for 15 hours. After cooling to room temperature, the mixture is then concentrated under reduced pressure, the residue is poured into 1 ml of 2N hydrochloric acid and the mixture is extracted with methylene chloride. The organic extract is dried with sodium sulfate and filtered. From the filtrate, the solvent is carefully distilled off under reduced pressure.

This gives 0.17 g (30% of theory) of 3-[4-cyano-2-fluoro-5-(1-cyclopropyl-2,4-dioxoimidazolidin-3-yl)phenyl]-1-methyl-6-trifluoromethyl-1H-pyrimid ine-2,4-dione.

log P(pH=2.3): 2.25

Analogously to Preparation Examples 1 to 3 and in accordance with the general description of the preparation processes according to the invention, it is also possible to prepare, for example, the compounds of the formula (I) listed in Table 1 below.

TABLE 1
Examples of the compounds of the formula (I)

| | |
|---|---|
| | (I) |
| 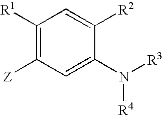 | |

| Ex. No. | R¹ | R² | 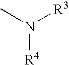 | Z | Physical data |
|---|---|---|---|---|---|
| 4 | F | CN | 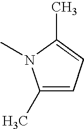 | 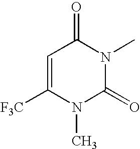 | ¹H-NMR (CD₃CN, δ): 5.91 ppm(S, 2H) |
| 5 | F | CN | 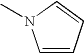 | 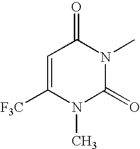 | ¹H-NMR (DMSO-D₆, δ): 6.64 ppm(S, 1H) |
| 6 | F | CN | 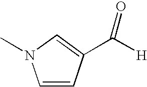 | 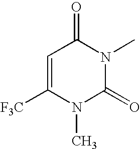 | m.p.: 174° C. logP = 2.25^{a)} |
| 7 | F | CN | 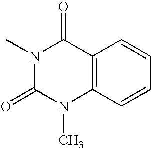 | 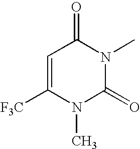 | logP = 2.77^{a)} |
| 8 | F | CN | 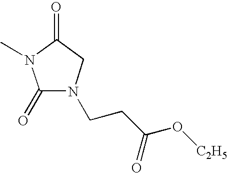 | 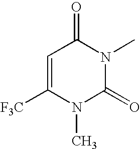 | logP = 2.48^{a)} |
| 9 | F | CN | 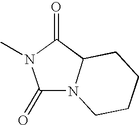 | 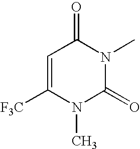 | logP = 2.42^{a)} |
| 10 | F | CN | 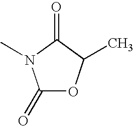 | 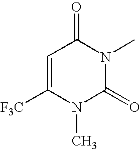 | logP = 2.49^{a)} |
| 11 | F | CN | 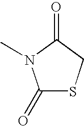 | 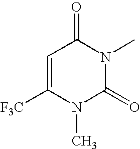 | logP = 2.36^{a)} |
| 12 | F | CN | 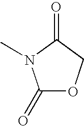 | 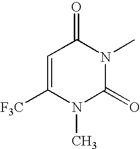 | ¹H-NMR (DMSO-D₆, δ): 6.61 ppm(S, 1H) |
| 13 | F | CN | 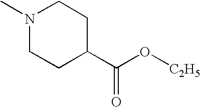 | 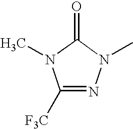 | logP = 3.35^{a)} |
| 14 | F | CN | 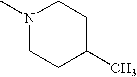 | 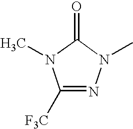 | logP = 3.91^{a)} |
| 15 | F | CN | 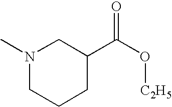 | 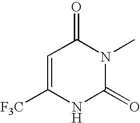 | |
| 16 | F | CN | 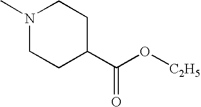 | 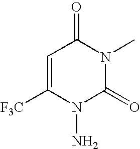 | logP = 2.89^{a)} |
| 17 | F | CN | 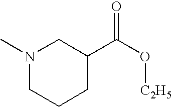 | 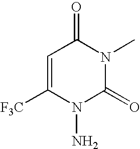 | logP = 2.99^{a)} |
| 18 | F | CN | 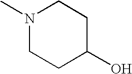 | 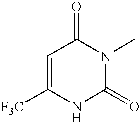 | logP = 1.62^{a)} |
| 19 | F | CN | 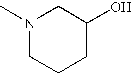 | 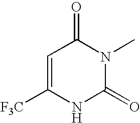 | logP = 1.76^{a)} |
| 20 | F | CN | 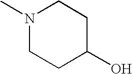 | 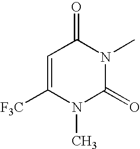 | logP = 3.97^{a)} |
| 21 | F | CN | 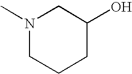 | 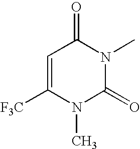 | logP = 2.16^{a)} |
| 22 | F | CN | 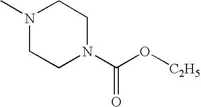 | 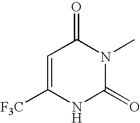 | |
| 23 | F | CN | 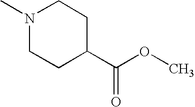 | 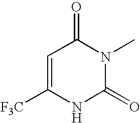 | |
| 24 | F | CN | 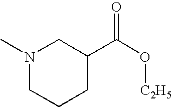 | 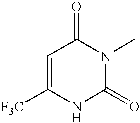 | logP = 3.31^{a)} |
| 25 | F | CN | 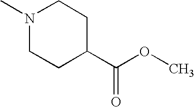 | 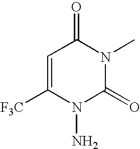 | logP = 2.59^{a)} |
| 26 | F | CN | 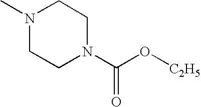 | 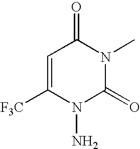 | logP = 2.53^{a)} |
| 27 | F | CN | 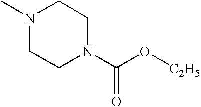 | 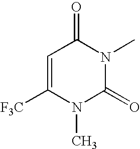 | logP = 2.80^{a)} |
| 28 | F | CN | 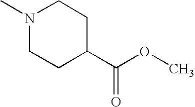 | 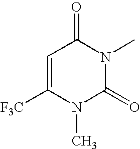 | logP = 2.88^{a)} |
| 29 | F | CN | 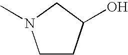 | 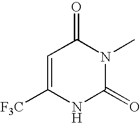 | |
| 30 | F | CN | 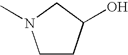 | 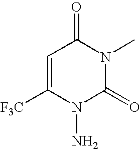 | logP = 1.79^{a)} |
| 31 | F | CN | 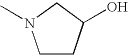 | 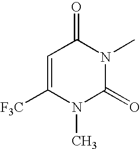 | logP = 2.02^{a)} |
| 32 | F | CN | 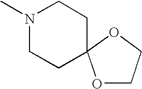 | 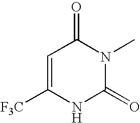 | |
| 33 | F | CN | 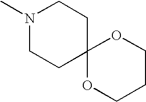 | 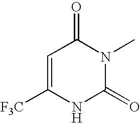 | |
| 34 | F | CN | 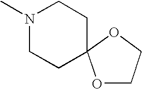 | 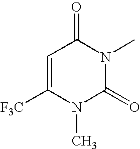 | logP = 2.67^{a)} |
| 35 | F | CN | 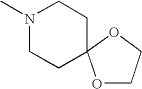 | 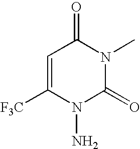 | logP = 2.37^{a)} |
| 36 | F | CN | 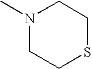 | 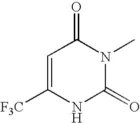 | logP = 2.34^{a)} |
| 37 | F | CN | 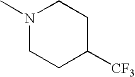 | 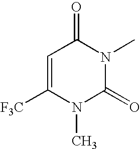 | logP = 3.52^{a)} |
| 38 | F | CN | 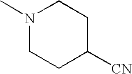 | 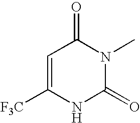 | logP = 2.08^{a)} |
| 39 | F | CN | 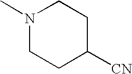 | 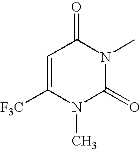 | logP = 2.62^{a)} |
| 40 | F | CN | 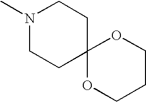 | 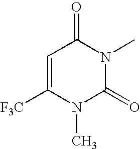 | logP = 2.69^{a)} |
| 41 | F | CN | 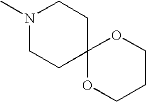 | 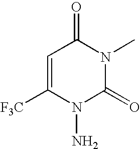 | logP = 2.40^{a)} |
| 42 | F | CN | 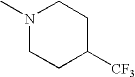 | 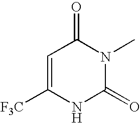 | logP = 2.96^{a)} |
| 43 | F | CN | 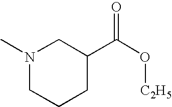 | 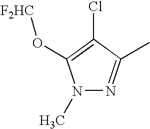 | logP = 4.05^{a)} |
| 44 | F | CN | 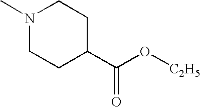 | 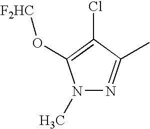 | logP = 3.98^{a)} |
| 45 | F | CN | 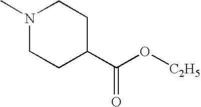 | 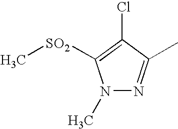 | logP = 3.36^{a)} |
| 46 | F | NO₂ | 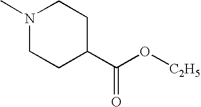 | 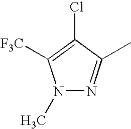 | logP = 4.83^{a)} |
| 47 | F | CN | 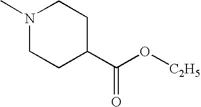 | 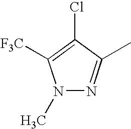 | logP = 4.64^{a)} |
| 48 | F | CN | 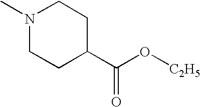 | 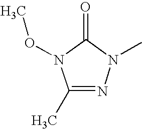 | logP = 2.56^{a)} |
| 49 | F | CN | 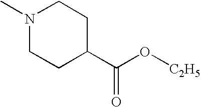 | 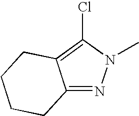 | logP = 4.79^{a)} |
| 50 | F | CN | 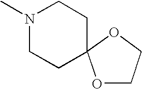 | 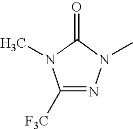 | logP = 2.81^{a)} |
| 51 | F | NO₂ | 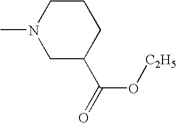 | 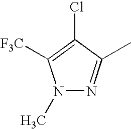 | |
| 52 | F | CN | 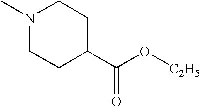 | 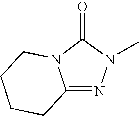 | |
| 53 | F | CN | 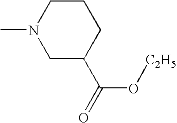 | 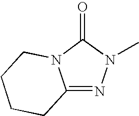 | |
| 54 | F | CN | 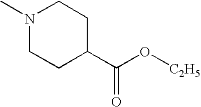 | 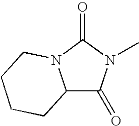 | |
| 55 | F | CN | 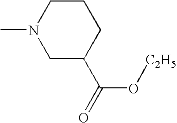 | 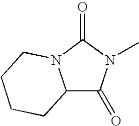 | |
| 56 | F | CN | 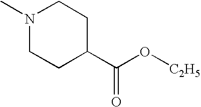 | 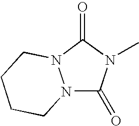 | |
| 57 | F | CN | 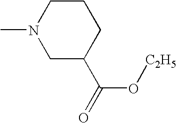 | 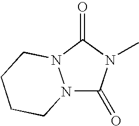 | |
| 58 | F | CN | 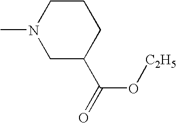 | 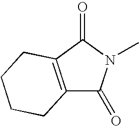 | |
| 59 | F | CN | 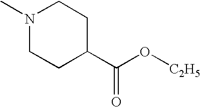 | 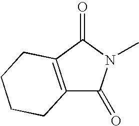 | logP = 3.77^{a)} |
| 60 | F | CN | 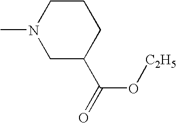 | 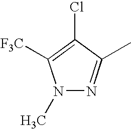 | |
| 61 | F | CN | 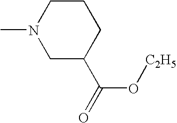 | 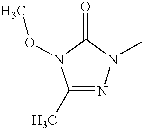 | |
| 62 | F | CN | 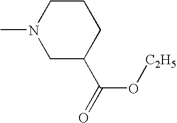 | 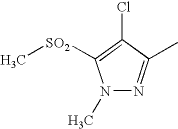 | |
| 63 | F | CN | 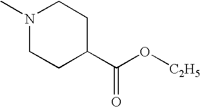 | 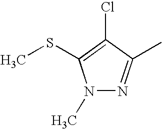 | logP = 4.30^{a)} |
| 64 | F | CN | 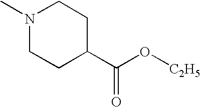 | 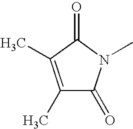 | logP = 3.37^{a)} |
| 65 | F | Cl | 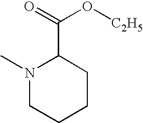 | 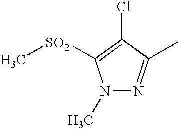 | logP = 4.48^{a)} |
| 66 | F | Cl | 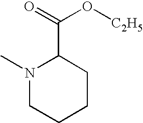 | 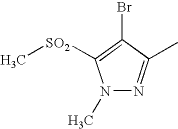 | logP = 4.47^{a)} |
| 67 | F | Cl | 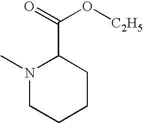 | 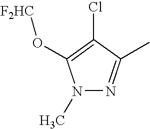 | logP = 5.15^{a)} |
| 68 | F | Cl | 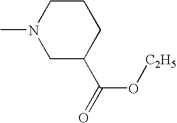 | 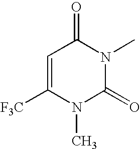 | logP = 3.87^{a)} |
| 69 | F | Cl | 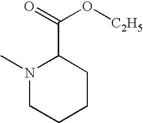 | 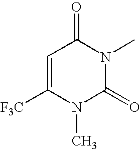 | logP = 4.07^{a)} |
| 70 | F | Cl | 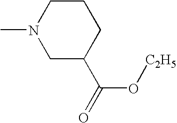 | 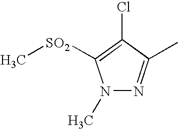 | logP = 4.28^{a)} |
| 71 | F | Cl | 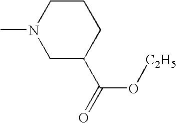 | 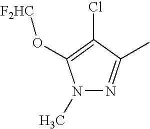 | logP = 4.95^{a)} |
| 72 | F | Cl | 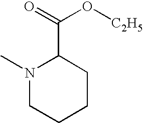 | 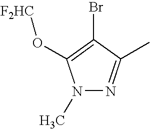 | logP = 5.14^{a)} |
| 73 | F | Br | 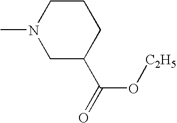 | 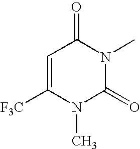 | logP = 3.99^{a)} |
| 74 | F | Br | 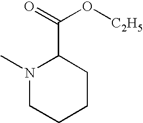 | 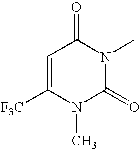 | logP = 4.18^{a)} |
| 75 | F | Cl | 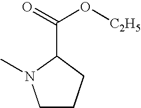 | 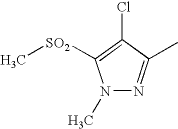 | logP = 3.79^{a)} |
| 76 | F | Cl | 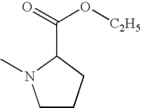 | 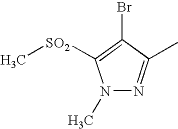 | logP = 3.77^{a)} |
| 77 | F | Cl | 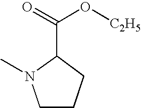 | 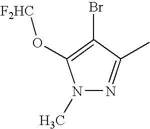 | logP = 4.40^{a)} |
| 78 | F | Cl | 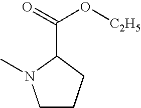 | 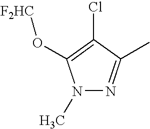 | logP = 4.41^{a)} |
| 79 | Cl | Cl | 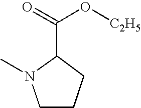 | 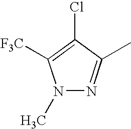 | logP = 5.39^{a)} |
| 80 | F | Cl | 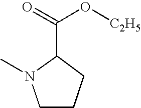 | 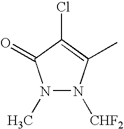 | logP = 3.38^{a)} |
| 81 | F | Cl | 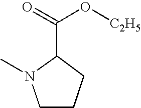 | 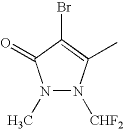 | logP = 3.37^{a)} |
| 82 | F | Br | 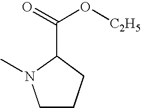 | 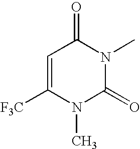 | logP = 3.61^{a)} |
| 83 | F | Cl | 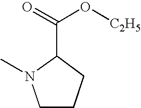 | 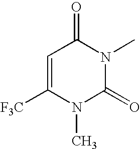 | logP = 3.49^{a)} |
| 84 | F | CN | 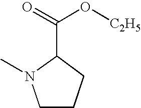 | 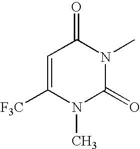 | logP = 3.01^{a)} |

The log P values given in the table were determined in accordance with EEC directive 79/831 Annex V.A8 by HPLC (High Performance Liquid Chromatography) using a reverse-phase column (C 18). Temperature: 43° C.

(a) Mobile phases for the determination in the acidic range: 0.1% aqueous phosphoric acid, acetonitrile; linear gradient from 10% acetonitrile to 90% acetonitrile—corresponding measurement results are marked a) in Table 1.

(b) Mobile phases for the determination in the neutral range: 0.01 molar aqueous phosphate buffer solution, acetonitrile; linear gradient from 10% acetonitrile to 90% acetonitrile—corresponding measurement results are marked b) in Table 1.

Calibration was carried out using unbranched alkan-2-ones (having 3 to 16 carbon atoms) with known log P values (determination of the log P values by the retention times using linear interpolation between two successive alkanones).

The lambda max values were determined in the maxima of the chromatographic signals using the UV spectra from 200 nm to 400 nm.

The compound listed as Example 75 in Table 1 can be prepared, for example, as follows:

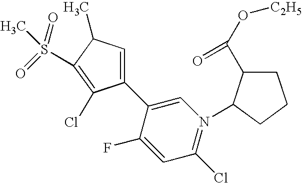

A solution of 0.68 g (2.0 mmol) of {2-chloro-5-[4-chloro-1-methyl-5-(methylsulfonyl)-1H-pyrazol-3-yl]4-fluorophenyl}amine, 0.58 g (2.0 mmol) of ethyl 2,5-dibromopentanecarboxylate and 0.62 g (4.8 mmol) of N,N-diisopropyl-N-ethylamine in 5 ml of toluene is heated under reflux for 35 hours. After cooling, during which N,N-diisopropyl-N-ethylamine hydrobromide precipitates, 20 ml of ethyl acetate are added and the mixture is washed three times with 10 ml of water. The organic phase is dried over magnesium sulfate, concentrated and purified chromatographically (silica gel, n-hexane/ethyl acetate 2:1).

This gives 0.36 g (39% of theory) of ethyl 1-{2-chloro-5-[4-chloro-1-methyl-5-(methylsulfonyl)-1H-pyrazol-3-yl]-4-fluorophenyl}prolinecarboxylate

(log P=3.79).

Starting Materials of the Formula (IV):

### Example IV-1

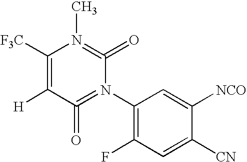

0.50 g (1.07 mmol) of 3-(5-amino-4-cyano-2-fluorophenyl)-1-methyl-6-trifluoro-methyl-1H-pyrimidine-2,4-dione is initially charged in 50 ml of acetone, 0.24 g (1.23 mmol) of trichloromethyl chloroformate (“diphosgene”) is added dropwise and the mixture is stirred at room temperature (about 20° C.) for 2 hours. The volatile components are then carefully distilled off under reduced pressure.

The product obtained in this manner as residue can be used without further purification for preparing compounds of the formula (I) according to the invention.

### USE EXAMPLES

### Example A

Pre-Emergence Test

| | |
|---|---|
| Solvent: | 5 parts by weight of acetone |
| Emulsifier: | 1 part by weight of alkylaryl polyglycol ether |

To produce a suitable preparation of active compound, 1 part by weight of active compound is mixed with the stated amount of solvent, the stated amount of emulsifier is added and the concentrate is diluted with water to the desired concentration.

Seeds of the test plants are sown in normal soil. After 24 hours, the soil is sprayed with the preparation of active compound such that the particular amount of active compound desired is applied per unit area. The concentration of active compound in the spray liquor is chosen such that the particular amount of active compound desired is applied in 1 000 liters of water per hectare.

After three weeks, the degree of damage to the plants is rated in % damage in comparison to the development of the untreated control. The figures denote:
0%=no effect (like untreated control)
100%=total destruction

In this test, for example, the compounds of Preparation Examples 2, 3, 4, 5, 6, 9, 16, 17, 20, 21, 24, 25, 26, 27, 28, 30 and 31 exhibit very strong activity against weeds whilst being tolerated well by some crop plants, such as, for example, corn and sugar beet.

### Example B

Post-Emergence Test

| | |
|---|---|
| Solvent: | 5 parts by weight of acetone |
| Emulsifier: | 1 part by weight of alkylaryl polyglycol ether |

To produce a suitable preparation of active compound, 1 part by weight of active compound is mixed with the stated amount of solvent, the stated amount of emulsifier is added and the concentrate is diluted with water to the desired concentration.

Test plants of a height of 5-15 cm are sprayed with the preparation of active compound such that the particular amounts of active compound desired are applied per unit area. The concentration of the spray liquor is chosen such that the particular amounts of active compound desired are applied in 1 000 l of water/ha.

After three weeks, the degree of damage to the plants is rated in % damage in comparison to the development of the untreated control.

The figures denote:
0%=no effect (like untreated control)
100%=total destruction

In this test, for example, the compounds of Preparation Examples 2, 3, 4, 5, 6, 7, 9, 10, 11, 12, 16, 17, 20, 21, 24, 25, 26, 27, 28, 30 and 31 exhibit very strong activity against weeds, whilst being tolerated well by some crop plants, such as, for example, wheat.

### Example C

Tetranychus Test (OP-Resistant/Spray Treatment)

| | |
|---|---|
| Solvents: | 78 parts by weight of acetone |
| | 1.5 parts by weight of dimethylformamide |
| Emulsifier: | 0.5 part by weight of alkylaryl polyglycol ether |

To produce a suitable preparation of active compound, 1 part by weight of active compound is mixed with the stated amounts of solvent and emulsifier, and the concentrate is diluted with emulsifier-containing water to the desired concentration.

Discs of bean leaves (Phaseolus vulgaris) which are infested by all stages of the greenhouse red spider mite (Tetranychus urticae) are sprayed with a preparation of active compound of the desired concentration.

After the desired period of time, the effect in % is determined. 100% means that all spider mites have been killed; 0% means that none of the spider mites have been killed.

In this test, for example, the compounds of Preparation Examples 7, 8 and 9 exhibit good activity.

1. A compound of the formula (I), 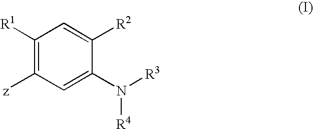
in which
R¹ represents hydrogen, cyano or halogen,
R² represents nitro, chlorine, bromine, cyano, thiocarbamoyl or represents in each case optionally halogen-substituted alkyl or alkoxy having in each case 1 to 6 carbon atoms,
R³ and R⁴ together with the N atom to which they are attached represent monocyclic or bicyclic (including spirocyclic) heterocyclyl which has up to 10 carbon atoms, up to 5 N atoms and optionally additionally one O atom or one S atom and which optionally contains 1 or 2 oxo groupings (C═O), thioxo groupings (C═S) or sulfonyl groupings (SO₂) and which is optionally substituted by hydroxyl, amino, nitro, cyano, carbamoyl, thiocarbamoyl, formyl, halogen, C₁-C₆-alkyl, cyano-C₁-C₆-alkyl, C₁-C₆-haloalkyl, C₁-C₆-alkoxy-C₁-C₆-alkyl, C₁-C₆-alkyl-carbonyl-C₁-C₆-alkyl, C₁-C₆-alkoxy-carbonyl-C₁-C₆-alkyl, C₁-C₆-alkoxy, C₁-C₆-haloalkoxy, C₁-C₆-alkylthio, C₁-C₆-haloalkylthio, C₁-C₆-alkylsulfinyl, C₁-C₆-haloalkylsulfinyl, C₁-C₆-alkylsulfonyl, C₁-C₆-haloalkylsulfonyl, C₁-C₆-alkyl-carbonyl, C₁-C₆-haloalkyl-carbonyl, C₁-C₆-alkoxy-carbonyl, C₁-C₆-haloalkoxy-carbonyl, C₁-C₆-alkylamino-carbonyl, di-(C₁-C₄-alkyl)aminocarbonyl, di-(C₁-C₄-alkyl)aminosulfonyl, C₁-C₃-alkylenedioxy, C₁-C₃-haloalkylenedioxy or C₃-C₆-cycloalkyl, and
Z represents one of the heterocyclic groupings (Z¹) to (Z⁵¹) below 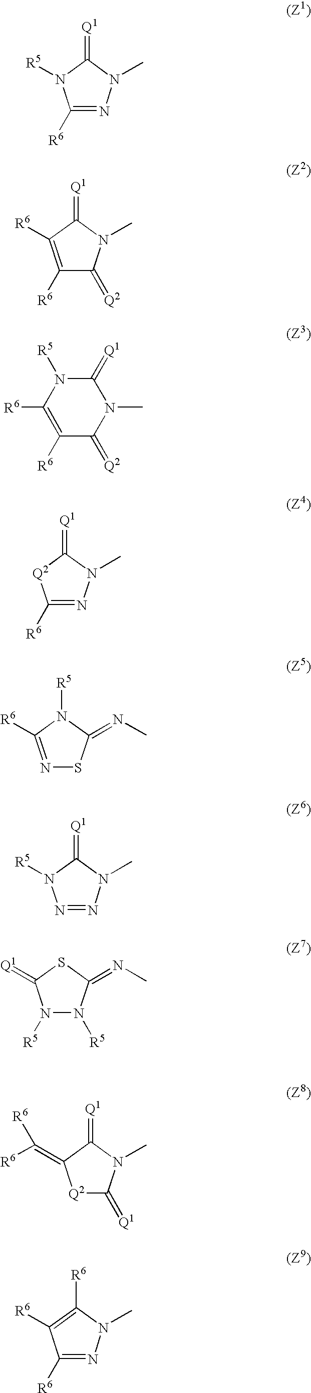 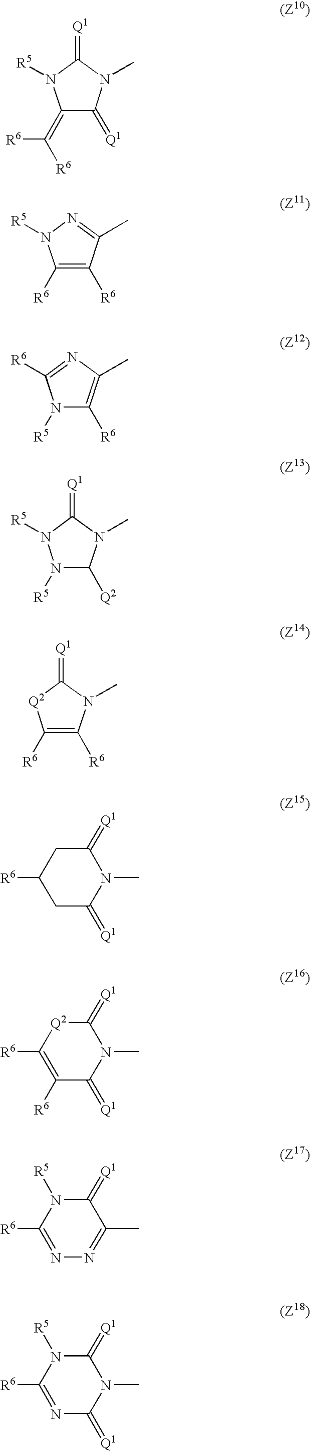 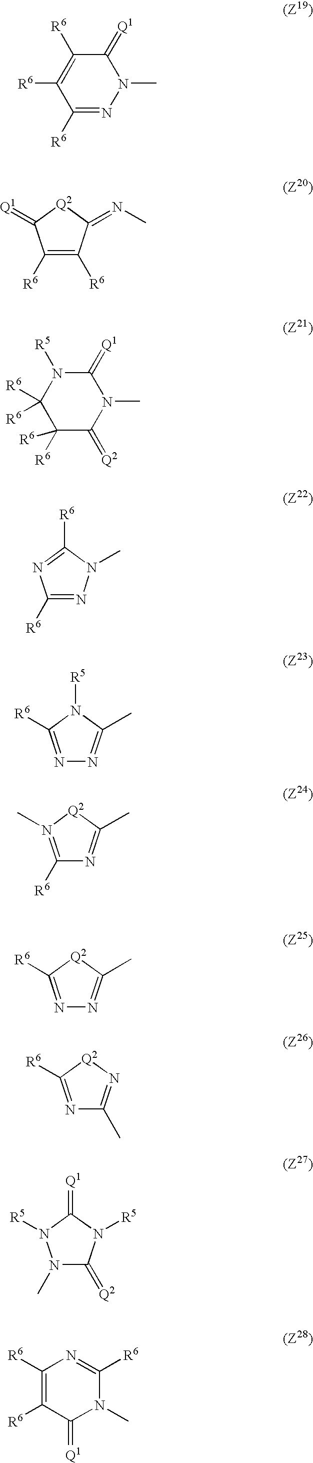 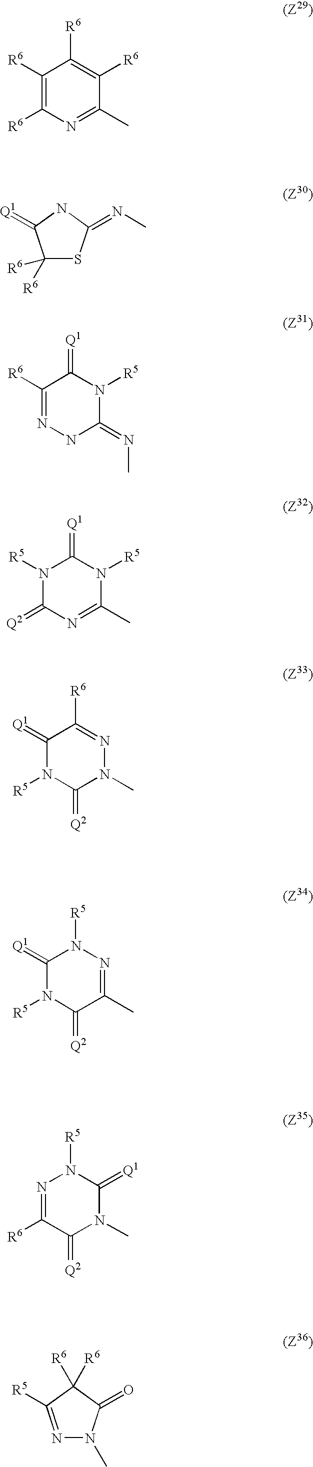 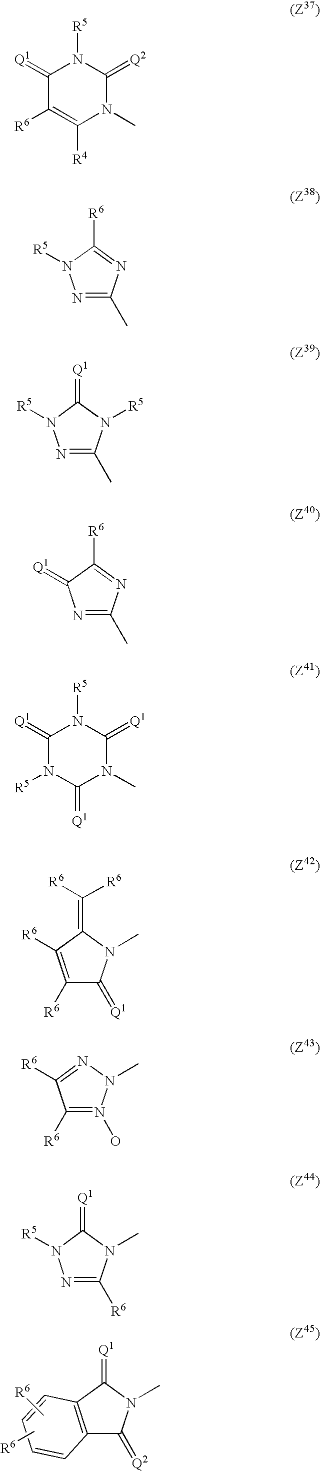 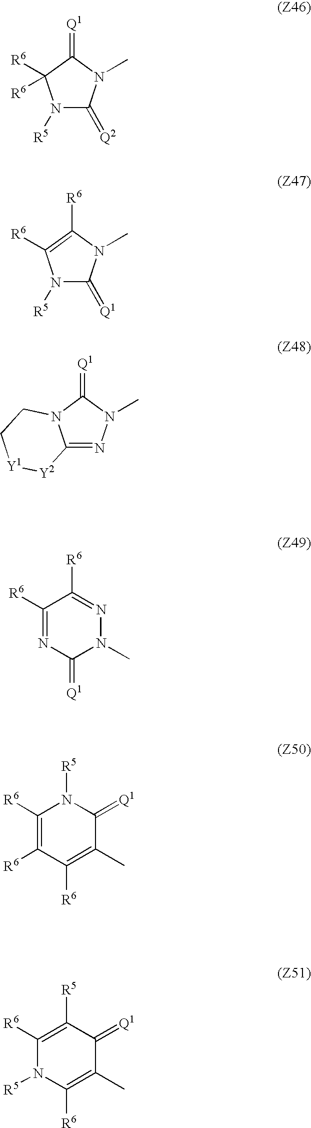
where
Q¹ represents O (oxygen) or S (sulfur),
Q² represents O (oxygen) or S (sulfur),
R⁵ represents hydrogen, hydroxyl, amino, cyano, or represents in each case optionally cyano-, halogen- or C₁-C₆-alkoxy-substituted alkyl, alkoxy or alkoxycarbonyl having in each case 1 to 6 carbon atoms in the alkyl groups, in each case optionally cyano-, halogen- or C₁-C₆-alkoxy-carbonyl-substituted alkenyl or alkynyl having in each case 2 to 6 carbon atoms, represents in each case optionally cyano-, halogen- or C₁-C₄-alkyl-substituted cycloalkyl or cycloalkylalkyl having in each case 3 to 6 carbon atoms in the cycloalkyl group and, if appropriate, 1 to 4 carbon atoms in the alkyl moiety, or represents in each case optionally cyano-, nitro-, halogen-, C₁-C₄-alkyl-, C₁-C₄-haloalkyl-, Cl-C₄-alkoxy- or C₁-C₄-haloalkoxy-substituted phenyl or phenyl-C₁-C₄-alkyl, and
R⁶ represents hydrogen, amino, nitro, cyano, carboxyl, carbamoyl, thiocarbamoyl, halogen, represents in each case optionally cyano-, halogen- or C₁-C₄-alkoxy-substituted alkyl, alkoxy, alkoxycarbonyl, alkylthio, alkylsulfinyl, alkylsulfonyl, alkylsulfonyloxy, alkylamino or dialkylamino having in each case 1 to 6 carbon atoms in the alkyl groups, represents in each case optionally cyano- or halogen-substituted alkenyl, alkynyl, alkenyloxy, alkynyloxy, alkenylthio or alkynylthio having in each case 2 to 6 carbon atoms, or represents in each case optionally cyano-, halogen- or C₁-C₄-alkyl-substituted cycloalkyl or cycloalkylalkyl having in each case 3 to 6 carbon atoms in the cycloalkyl group and, if appropriate, 1 to 4 carbon atoms in the alkyl moiety,
where, if appropriate, two adjacent radicals—R⁵ and R⁵, R⁶ and R⁶ or R⁵ and R⁶—together represent alkanediyl or alkenediyl having in each case up to 6 carbon atoms and being optionally substituted and/or optionally interrupted by O (oxygen), S (sulfur) or a grouping from the group consisting of —SO—, —SO₂—, —NH— or —N(C₁-C₄-alkyl)- at the beginning (or at the end) or within the hydrocarbon chain,
Y¹ represents O (oxygen), S (sulfur), SO, SO₂, NH, N(C₁-C₄-alkyl) or methylene and
Y² represents a single bond or represents O (oxygen), S (sulfur), SO, SO₂, NH or N(C₁-C₄-alkyl),
where in each individual case Y¹ and Y² are different.

2. The compound of the formula (I) as claimed in claim 1, wherein
R¹ represents hydrogen, cyano, fluorine, chlorine or bromine,
R² represents nitro, chlorine, bromine, cyano, thiocarbamoyl or represents in each case optionally fluorine- and/or chlorine-substituted alkyl or alkoxy having in each case 1 to 4 carbon atoms,
R³ and R⁴ together with the N atom to which they are attached represent monocyclic or bicyclic (including spirocyclic) heterocyclyl which has up to 9 carbon atoms, up to 4 N atoms and optionally additionally one O atom or one S atom, which optionally contains 1 or 2 oxo groupings (C═O), thioxo groupings (C═S) or sulfonyl groupings (SO₂) and which is optionally substituted by hydroxyl, amino, nitro, cyano, carbamoyl, thiocarbamoyl, formyl, halogen, C₁-C₄-alkyl, cyano-C₁-C₄-alkyl, C₁-C₄-haloalkyl, C₁-C₄-alkoxy-C₁-C₄-alkyl C₁-C₄-alklyl-carbonyl-C₁-C₄-alkyl, C₁-C₄-alkoxy-carbonyl-C₁-C₄-alkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₄-alkyl-carbonyl, C₁-C₄-haloalkyl-carbonyl, C₁-C₄-alkoxy-carbonyl, C₁-C₄-haloalkoxy-carbonyl, C₁-C₄-alkylamino-carbonyl, di-(C₁-C₃-alkyl)aminocarbonyl, di-(C₁-C₃-alkyl)aminosulfonyl, C₁-C₃-alkylenedioxy, C₁-C₂-haloalkylenedioxy or C₃-C₆-cycloalkyl,
Q¹ represents O (oxygen),
Q² represents O (oxygen),
R⁵ represents hydrogen, hydroxyl, amino, cyano, represents in each case optionally cyano-, halogen- or C₁-C₄-alkoxy-substituted alkyl, alkoxy or alkoxycarbonyl having in each case 1 to 5 carbon atoms in the alkyl groups, represents in each case optionally cyano-, halogen- or C₁-C₄-alkoxy-carbonyl-substituted alkenyl or alkynyl having in each case 2 to 5 carbon atoms, represents in each case optionally cyano-, halogen- or C₁-C₃-alkyl-substituted cycloalkyl or cycloalkylalkyl having in each case 3 to 6 carbon atoms in the cycloalkyl group and, if appropriate, 1 to 3 carbon atoms in the alkyl moiety, or represents in each case optionally cyano-, nitro-, halogen-, C₁-C₄-alkyl-, C₁-C₄-haloalkyl-, C₁-C₄-alkoxy- or C₁-C₄-haloalkoxy-substututed phenyl or phenyl-C₁-C₃-alkyl,
R⁶ represents hydrogen, amino, nitro, cyano, carboxyl, carbamoyl, thiocarbamoyl, halogen, represents in each case optionally cyano-, halogen- or C₁-C₄-alkoxy-substituted alkyl, alkoxy, alkoxycarbonyl, alkylthio, alkylsulfinyl, alkylsulfonyl, alkylsulfonyloxy, alkylamino or dialkylamino having in each case 1 to 5 carbon atoms in the alkyl groups, represents in each case optionally cyano- or halogen-substituted alkenyl, alkynyl, alkenyloxy, alkynyloxy, alkenylthio or alkynylthio having in each case 2 to 5 carbon atoms, or represents in each case optionally cyano-, halogen- or C₁-C₄-alkyl-substituted cycloalkyl or cycloalkylalkyl having in each case 3 to 6 carbon atoms in the cycloalkyl group and, if appropriate, 1 to 3 carbon atoms in the alkyl moiety and
two adjacent radicals—R⁵ and R⁵, R⁶ and R⁶ or R⁵ and R⁶—optionally together represent alkanediyl or alkenediyl having in each case up to 6 carbon atoms and being in each case optionally substituted and/or optionally interrupted by O (oxygen), S (sulfur) or a grouping from the group consisting of —SO—, —SO₂—, —NH— or —N(C₁-C₄-alkyl)- at the beginning (or at the end) or within the hydrocarbon chain.

3. The compound of the formula (I) as claimed in claim 1, wherein
R¹ represents hydrogen, fluorine or chlorine,
R² represents nitro, cyano, thiocarbamoyl, or represents in each case optionally fluorine- and/or chlorine-substituted methyl, ethyl, n- or i-propyl, methoxy, ethoxy, n- or i-propoxy,
R³ and R⁴ together with the N atom to which they are attached represent monocyclic or bicyclic (including spirocyclic) heterocyclyl which has up to 9 carbon atoms, up to 4 N atoms and optionally additionally one O atom or one S atom, which optionally contains 1 or 2 oxo groupings (C═O), thioxo groupings (C═S) or sulfonyl groupings (SO₂) and which is optionally substituted by hydroxyl, amino, nitro, cyano, carbamoyl, thiocarbamoyl, formyl, fluorine, chlorine, bromine, methyl, ethyl, n- or i-propyl, n-, i-, s- or t-butyl, cyanomethyl, cyanoethyl, fluoromethyl, difluoromethyl, trifluoromethyl, fluoroethyl, difluoroethyl, trifluoroethyl, tetrafluoroethyl, pentafluoroethyl, chloromethyl, dichloromethyl, trichloromethyl, chloroethyl, dichloroethyl, trichloroethyl, chlorofluoromethyl, chlorodifluoromethyl, fluorodichloromethyl, chlorofluoroethyl, chlorodifluoroethyl, fluorodichloroethyl, chlorotrifluoroethyl, methoxymethyl, ethoxymethyl, methoxyethyl, ethoxyethyl, acetylmethyl, propionylmethyl, n- or i-butyroylmethyl, methoxycarbonylmethyl, ethoxycarbonylmethyl, n- or ipropoxycarbonylmethyl, methoxycarbonylethyl, ethoxycarbonylethyl, n- or i-propoxycarbonylethyl, methoxy, ethoxy, n- or i-propoxy, n-, i-, s- or t-butoxy, fluoromethoxy, difluoromethoxy, trifluoromethoxy, chlorodifluoromethoxy, fluoroethoxy, chloroethoxy, difluoroethoxy, dichloroethoxy, chlorofluoroethoxy, chlorodifluoroethoxy, trifluoroethoxy, methylthio, ethylthio, n- or i-propylthio, n-, i-, s- or t-butylthio, difluoromethylthio, trifluoromethylthio, chlorodifluoromethylthio, fluoroethylthio, chloroethylthio, difluoroethylthio, dichloroethylthio, chlorofluoroethylthio, chlorodifluoroethylthio, trifluoroethylthio, chlorodifluoroethylthio, methylsulfinyl, ethylsulfinyl, propylsulfinyl, trifluoromethylsulfinyl, fluoroethylsulfinyl, chloroethylsulfinyl, chlorofluoroethylsulfinyl, difluoroethylsulfinyl, chlorodifluoroethylsulfinyl, trifluoroethylsulfinyl, methylsulfonyl, ethylsulfonyl, trifluoromethylsulfonyl, acetyl, propionyl, n- or i-butyroyl, chloroacetyl, dichloroacetyl, trichloroacetyl, difluoroacetyl, trifluoroacetyl, methoxycarbonyl, ethoxycarbonyl, n- or i-propoxycarbonyl, n-, i-, s- or t-butoxycarbonyl, chloroethoxycarbonyl, fluoroethoxycarbonyl, methylaminocarbonyl, ethylaminocarbonyl, n- or i-propylaminocarbonyl, dimethylamino-carbonyl, diethylaminocarbonyl, dimethylaminosulfonyl, diethylaminosulfonyl, methylenedioxy, ethylenedioxy, difluoromethylenedioxy, difluoroethylenedioxy, trifluoroethylenedioxy, tetrafluoroethylenedioxy, chlorodifluoroethylenedioxy, cyclopropyl, cyclobutyl, cyclopentyl or cyclohexyl,
Z represents one of the heterocyclic groupings (Z¹), (Z²), (Z³), (Z¹¹), (Z¹³) or (Z⁴⁶) below 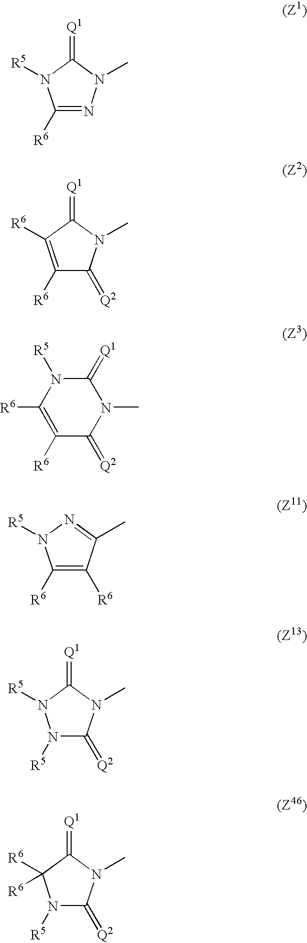
R⁵ represents hydrogen, hydroxyl, amino, cyano, or represents in each case optionally cyano-, fluorine-, chlorine-, bromine-, methoxy-, ethoxy-, n- or i-propoxy-substituted methyl, ethyl, n- or i-propyl, n-, i-, s- or t-butyl, methoxy, ethoxy, n- or i-propoxy, n-, i-, s- or t-butoxy, methoxycarbonyl, ethoxycarbonyl, n- or i-propoxycarbonyl, n-, i-, s- or t-butoxycarbonyl, represents in each case optionally cyano-, fluorine-, chlorine-, bromine-, methoxycarbonyl-, ethoxycarbonyl-, n- or i-propoxycarbonyl-, n-, i-, s- or t-butoxycarbonyl-substituted ethenyl, propenyl, butenyl, ethynyl, propynyl or butynyl, represents in each case optionally cyano-, fluorine-, chlorine-, bromine-, methyl- or ethyl-substituted cyclopropyl, cyclobutyl, cyclopentyl, cyclohexyl, cyclopropylmethyl, cyclobutylmethyl, cyclopentylmethyl or cyclohexylmethyl, or represents in each case optionally cyano-, nitro-, fluorine-, chlorine-, bromine-, iodine-, methyl-, ethyl-, n- or i-propyl-, n-, i-, s- or t-butyl-, fluoromethyl-, chloromethyl-, difluoromethyl-, di-chloromethyl-, trifluoromethyl-, trichloromethyl-, fluorodichloromethyl-, methoxy-, ethoxy-, n- or i-propoxy-, n-, i-, s- or t-butoxy-, fluoromethoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trifluoroethoxy- or chlorodifluoroethoxy-substituted phenyl, benzyl or phenylethyl,
R⁶ represents hydrogen, amino, nitro, cyano, carboxyl, carbamoyl, thiocarbamoyl, fluorine, chlorine, bromine, iodine, represents in each case optionally cyano-, fluorine-, chlorine-, methoxy-, ethoxy-, n- or i-propoxy-substituted methyl, ethyl, n- or i-propyl, n-, i-, s- or t-butyl, methoxy, ethoxy, n- or i-propoxy, n-, i-, s- or t-butoxy, methoxycarbonyl, ethoxycarbonyl, n- or i-propoxycarbonyl, n-, i-, s- or t-butoxycarbonyl, methylthio, ethylthio, n- or i-propylthio, n-, i-, s- or t-butylthio, methylsulfinyl, ethylsulfinyl, propylsulfinyl, methylsulfonyl, ethylsulfonyl, methylsulfonyloxy, ethylsulfonyloxy, methylamino, ethylamino, n- or i-propylamino, n-, i-, s- or t-butylamino, dimethylamino or diethylamino, or represents in each case optionally cyano-, fluorine-, chlorine- or bromine-substituted ethenyl, propenyl, butenyl, pentenyl, ethynyl, propynyl, butynyl, pentynyl, propenyloxy, butenyloxy, pentenyloxy, propynyloxy, butynyloxy, pentynyloxy, propenylthio, butenylthio, pentenylthio, propynylthio, butynylthio or pentynylthio, or represents in each case optionally cyano-, fluorine-, chlorine-, bromine-, methyl-, ethyl-, n- or i-propyl-substituted cyclopropyl, cyclobutyl, cyclopentyl, cyclohexyl, cyclopropylmethyl, cyclobutylmethyl, cyclopentylmethyl or cyclohexylmethyl, and
two adjacent radicals—R⁵ and R⁵, R⁶ and R⁶ or R⁵ and R⁶—optionally together represent alkanediyl or alkenediyl having in each case up to 6 carbon atoms and being in each case optionally substituted and/or optionally interrupted by O (oxygen), S (sulfur) or a grouping from the group consisting of —SO—, —SO₂—, —NH— or —N(methyl)- at the beginning (or at the end) or within the hydrocarbon chain.

4. The compound of the formula (I) as claimed in claim 1, wherein
R¹ represents fluorine or chlorine,
R² represents cyano or nitro,
R³ and R⁴ together with the N atom to which they are attached represent heterocyclyl from the group consisting of pyrrolyl, pyrrolinyl, pyrrolidinyl, pyrazolyl, piperidinyl, morpholinyl, thiomorpholinyl, piperazinyl, 2,4-dioxoimidazolidinyl, 2,4-dioxoperhydropyrimidinyl, 2,4-dioxoperhydrooxazolyl or 1,4-dioxoperhydrothiazolyl which is in each case optionally substituted by hydroxyl, nitro, cyano, carbamoyl, thiocarbamoyl, formyl, fluorine, chlorine, bromine, methyl, ethyl, n- or i-propyl, n-, i-, s- or t-butyl, cyanomethyl, cyanoethyl, fluoromethyl, difluoromethyl, trifluoromethyl, fluoroethyl, difluoroethyl, trifluoroethyl, tetrafluoroethyl, pentafluoroethyl, chloromethyl, dichloromethyl, trichloromethyl, chloroethyl, dichloroethyl, trichloroethyl, chlorofluoromethyl, chlorodifluoromethyl, fluorodichloromethyl, chlorofluoroethyl, chlorodifluoroethyl, fluorodichloroethyl, chlorotrifluoroethyl, methoxymethyl, ethoxymethyl, methoxyethyl, ethoxyethyl, acetylmethyl, propionylmethyl, n- or i-butyroylmethyl, methoxycarbonylmethyl, ethoxycarbonylmethyl, n- or i-propoxy-carbonylmethyl, methoxycarbonylethyl, ethoxycarbonylethyl, n- or i-propoxycarbonylethyl, methoxy, ethoxy, n- or i-propoxy, n-, i-, s- or t-butoxy, fluoromethoxy, difluoromethoxy, trifluoromethoxy, chlorodifluoromethoxy, fluoroethoxy, chloroethoxy, difluoroethoxy, dichloroethoxy, chlorofluoroethoxy, chlorodifluoroethoxy, trifluoroethoxy, methylthio, ethylthio, n- or i-propylthio, n-, i-, s- or t-butylthio, difluoromethylthio, trifluoromethylthio, chlorodifluoromethylthio, fluoroethylthio, chloroethylthio, difluoroethylthio, dichloroethylthio, chlorofluoroethylthio, chlorodifluoroethylthio, trifluoroethylthio, chlorodifluoroethylthio, methylsulfinyl, ethylsulfinyl, propylsulfinyl, trifluoromethylsulfinyl, fluoroethylsulfinyl, chloroethylsulfinyl, chlorofluoroethylsulfinyl, difluoroethylsulfinyl, chlorodifluoroethylsulfinyl, trifluoroethylsulfinyl, methylsulfonyl, ethylsulfonyl, trifluoromethylsulfonyl, acetyl, propionyl, n- or i-butyroyl, chloroacetyl, dichloroacetyl, trichloroacetyl, difluoroacetyl, trifluoroacetyl, methoxycarbonyl, ethoxycarbonyl, n- or i-propoxycarbonyl, n-, i-, s- or t-butoxycarbonyl, chloroethoxycarbonyl, fluoroethoxycarbonyl, methylaminocarbonyl, ethylaminocarbonyl, n- or i-propylaminocarbonyl, dimethylaminocarbonyl, diethylaminocarbonyl, dimethylaminosulfonyl, diethylaminosulfonyl, methylenedioxy, ethylenedioxy, difluoromethylenedioxy, difluoro-ethylenedioxy, trifluoroethylenedioxy, tetrafluoroethylenedioxy, chlorodifluoroethylenedioxy, cyclopropyl, cyclobutyl, cyclopentyl or cyclohexyl, and which is optionally benzo-fused or which is optionally linked to propane-1,3-diyl or butane-1,4-diyl, and
two adjacent radicals—R⁵ and R⁵, R⁶ and R⁶ or R⁵ and R⁶—optionally together represent alkanediyl having 4 carbon atoms.

5. The compound of the formula (I) as claimed in claim 1, wherein
R¹ represents fluorine,
R³ and R⁴ together with the N atom to which they are attached represent one of the heterocycles below 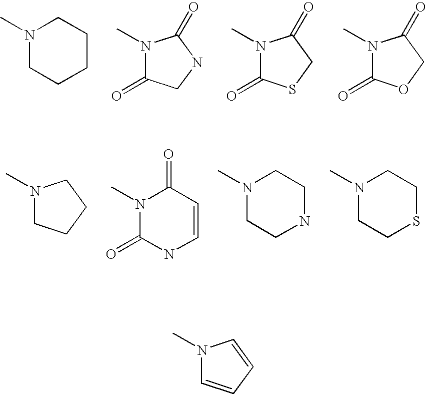
which is in each case optionally substituted by hydroxyl, nitro, cyano, carbamoyl, thiocarbamoyl, formyl, fluorine, chlorine, bromine, methyl, ethyl, n- or i-propyl, n-, i-, s- or t-butyl, cyanomethyl, cyanoethyl, fluoromethyl, difluoromethyl, trifluoromethyl, fluoroethyl, difluoroethyl, trifluoroethyl, tetrafluoroethyl, pentafluoroethyl, chloromethyl, dichloromethyl, trichloromethyl, chloroethyl, dichloroethyl, trichloroethyl, chlorofluoromethyl, chlorodifluoro-methyl, fluorodichloromethyl, chlorofluoroethyl, chlorodifluoroethyl, fluorodichloroethyl, chlorotrifluoroethyl, methoxymethyl, ethoxymethyl, methoxyethyl, ethoxyethyl, acetylmethyl, propionylmethyl, n- or i-butyroylmethyl, methoxycarbonylmethyl, ethoxycarbonylmethyl, n- or i-propoxycarbonylmethyl, methoxycarbonylethyl, ethoxycarbonylethyl, n- or i-propoxycarbonyl-ethyl, methoxy, ethoxy, n- or i-propoxy, n-, i-, s- or t-butoxy, fluoromethoxy, difluoromethoxy, trifluoromethoxy, chlorodifluoromethoxy, fluoroethoxy, chloroethoxy, difluoroethoxy, dichloroethoxy, chlorofluoroethoxy, chlorodifluoroethoxy, trifluorethoxy, inethylthio, ethylthio, n- or i-propylthio, n-, i-, s- or t-butylthio, difluoromethylthio, trifluoromethylthio, chlorodifluoro-methylthio, fluoroethylthio, chloroethylthio, difluorethylthio, dichloroethylthio, chlorofluoroethylthio, chlorodifluoroethylthio, trifluoroethylthio, chlorodifluoroethylthio, methylsulfinyl, ethylsulfinyl, propylsulfinyl, trifluoromethylsulfinyl, fluoroethylsulfinyl, chloroethylsulfinyl, chlorofluoroethylsulfinyl, difluoroethylsulfinyl, chlorodifluoroethylsulfinyl, trifluoroethylsulfinyl, methylsulfonyl, ethylsulfonyl, trifluoromethylsulfonyl, acetyl, propionyl, n- or i-butyroyl, chloroacetyl, dichloroacetyl, trichloroacetyl, difluoroacetyl, trifluoroacetyl, methoxycarbonyl, ethoxycarbonyl, n- or i-propoxycarbonyl, n-, i-, s- or t-butoxycarbonyl, chloroethoxycarbonyl, fluoroethoxycarbonyl, methylaminocarbonyl, ethylaminocarbonyl, n- or i-propylaminocarbonyl, dimethylaminocarbonyl, diethylaminocarbonyl, dimethylaminosulfonyl, diethylaminosulfonyl, methylenedioxy, ethylenedioxy, difluoromethylenedioxy, difluoroethylenedioxy, trifluoroethylenedioxy, tetrafluoroethylenedioxy, chlorodifluoroethylenedioxy, cyclopropyl, cyclobutyl, cyclopentyl or cyclohexyl, and which is optionally benzo-fused or which is optionally linked to propane-1,3-diyl or butane-1,4-diyl.

6. A process for preparing compounds of the formula (I) as claimed in claim 1, wherein
(a) N-aryl nitrogen heterocycles of the general formula (II) 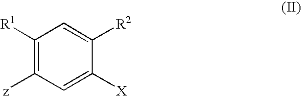
in which
R¹, R² and Z are as defined above and
X represents halogen
are reacted with nitrogen compounds of the general formula (III) 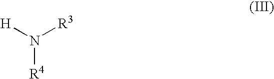
in which
R³ and R⁴ are as defined above,
if appropriate in the presence of one or more diluents and if appropriate in the presence of one or more reaction auxiliaries,
or wherein
(b) N-aryl nitrogen heterocycles of the general formula (IV) 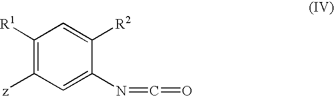
in which
R¹, R² and Z are as defined above
are reacted with alkyl carboxylates which contain nucleophilic groupings in the alpha position, if appropriate in the presence of one or more diluents and if appropriate in the presence of one or more reaction auxiliaries,
and the resulting compounds of the formula (I) are, if appropriate, converted by customary methods into other compounds of the formula (I).

7. A composition, which comprises at least one compound of the formula (I) as claimed in claim 1 and customary extenders.

8. A method for controlling unwanted plants, wherein the compound of the formula (I) as claimed in claim 1 is contacted with the plants and/or their habitat.

9. A method for controlling arthropods, wherein the compound of the formula (I) as claimed in claim 1 is contacted with the arthropods and/or their habitat.

10. A method of using the compounds of the formula (I) as claimed in claim 1, wherein said compounds are applied to plants and/or arthropods to act as herbicides and/or arthropodicides.
